(19) United States
(12) Patent Application Publication
(10) Pub. No.: US 2025/0336365 A1
(43) Pub. Date: Oct. 30, 2025

(54) DRIVING CIRCUIT OF DISPLAY PANEL AND DISPLAY DEVICE

(71) Applicant: BOE Technology Group Co., Ltd., Beijing (CN)

(72) Inventors: Donghui ZHAO, Beijing (CN); Pan XU, Beijing (CN); Ying HAN, Beijing (CN); Xing ZHANG, Beijing (CN); Chengyuan LUO, Beijing (CN); Guangshuang LV, Beijing (CN); Cheng XU, Beijing (CN); Hongli WANG, Beijing (CN); Tong WU, Beijing (CN); Dandan ZHOU, Beijing (CN)

(21) Appl. No.: 18/857,158

(22) PCT Filed: Jan. 16, 2024
(86) PCT No.: PCT/CN2024/072542

§ 371 Date: Jul. 24, 2025

(30) Foreign Application Priority Data
Feb. 17, 2023 (CN) 202310132255.2

(51) Int. Cl. G09G 3/3266

(52) U.S. Cl. CPC G09G 3/3266; G09G 2300/0413; G09G 2310/0286; G09G 2310/08; G09G 2330/021

(57) ABSTRACT

A driving circuit and a display device are provided. The driving circuit includes a gate driving circuit group and a light emission driving circuit group which are arranged sequentially in a pixel row direction. The gate driving circuit group includes a plurality of gate driving circuits arranged sequentially in the pixel row direction. The light emission driving circuit group includes a plurality of light emission driving circuits arranged sequentially in the pixel row direction. Each of the gate driving circuits includes a plurality of gate driving units cascade-connected along a pixel column direction. Each of the light emission driving circuits includes a plurality of light emission driving units cascade-connected along the pixel column direction.

The present disclosure is a national stage of PCT application No. PCT/CN2024/072542, filed on Jan. 16, 2024, which claims priority to Chinese Patent Application No. 202310132255.2, filed on Feb. 17, 2023 and entitled “DRIVING CIRCUIT OF DISPLAY PANEL AND DISPLAY DEVICE”, which is incorporated herein by reference in its entirety.

### TECHNICAL FIELD

The present disclosure relates to the field of display technologies, and in particular, relates to a driving circuit of a display panel and a display device.

### BACKGROUND ART

In the field of display technologies, a display device generally includes a display panel and a driving circuit thereof. The display panel includes a plurality of pixels, and the driving circuit is coupled to the plurality of pixels and configured to drive the plurality of pixels to emit light.

In the related art, the driving circuit may include a gate driving circuit and a light emission driving circuit. The gate driving circuit may include a plurality of gate driving units cascade-connected along a pixel column direction; and the light emission driving circuit may include a plurality of light emission driving units cascade-connected along the pixel column direction. The plurality of gate driving units may be coupled to a plurality of rows of pixels in one-to-one correspondence through a plurality of gate lines, and configured to transmit gate driving signals to the plurality of rows of pixels. The plurality of light emission driving units may be coupled to the plurality of rows of pixels in one-to-one correspondence through a plurality of light emission driving lines and configured to transmit light emission driving signals to the plurality of rows of pixels. For example, the light emission driving lines may include a light emission control line, a reset line and a compensation line. Correspondingly, the light emission driving signals may include a light emission control signal, a reset signal and a compensation signal. The plurality of pixels may be configured to emit light based on the received gate driving signals and the light emission driving signals.

However, for a display panel with high resolution, i.e., the display panel including a relatively large number of rows of pixels, each of the gate driving circuit and the light emission driving circuit needs to includes a large number of driving units cascade-connected along the pixel column direction, which is not conducive to layout arrangement.

### SUMMARY OF THE INVENTION

A driving circuit of a display panel and a display device are provided. The technical solutions are as follows.

In an aspect, a driving circuit of a display panel is provided, wherein the display panel includes a substrate, and a plurality of pixels disposed on the substrate and arranged in an array, wherein each of the pixels includes a plurality of sub-pixels which are arranged along a pixel column direction and have different colors; and the driving circuit includes:
a gate driving circuit group and a light emission driving circuit group which are arranged sequentially along a pixel row direction, wherein
the gate driving circuit group includes a plurality of gate driving circuits arranged sequentially along the pixel row direction, wherein each of the gate driving circuits includes a plurality of gate driving units cascade-connected along the pixel column direction;
the light emission driving circuit group includes a plurality of light emission driving circuits arranged sequentially along the pixel row direction, wherein each of the light emission driving circuits includes a plurality of light emission driving units cascade-connected along the pixel column direction;
the plurality of gate driving units included in the plurality of gate driving circuits are coupled to a plurality of rows of sub-pixels through a plurality of first output lines, the plurality of gate driving units included in each of the gate driving circuits are also coupled to a first start line and a plurality of first clock lines respectively, and the first output lines, the first start lines and the first clock lines coupled to the plurality of gate driving units included in the gate driving circuits are different; the plurality of gate driving units included in each of the gate driving circuits are configured to transmit gate driving signals to the coupled first output lines based on a first start signal provided by the coupled first start line and first clock signals provided by the coupled first clock lines;
the plurality of light emission driving units included in each of the light emission driving circuits are coupled to the plurality of rows of sub-pixels through a plurality of second output lines, the plurality of light emission driving units included in each of the light emission driving circuits are also coupled to a second start line and a plurality of second clock lines respectively, and the second output lines, the second start lines and the second clock lines coupled to the plurality of light emission driving units included in the light emission driving circuits are different; and the plurality of light emission driving units included in each of the light emission driving circuits are configured to transmit light emission driving signals to the coupled second output lines based on a second start signal provided by the coupled second start line and second clock signals provided by the coupled second clock lines.

Optionally, the light emission driving circuit group includes three light emission driving circuits: a light emission control circuit, a reset driving circuit and a compensation driving circuit; and
the plurality of gate driving circuits, the light emission control circuit, the reset driving circuit and the compensation driving circuit are arranged sequentially in a direction approaching to the pixels along the pixel row direction.

Optionally, the plurality of first clock lines is divided into a plurality of groups of first clock lines, and each group of first clock lines include at least two first clock lines;
each of the gate driving circuits includes a plurality of gate driving sub-circuits; each of the gate driving sub-circuits is coupled to the plurality of groups of first clock lines and includes a plurality of gate driving unit groups in one-to-one correspondence with the plurality of rows of pixels, and the gate driving sub-circuits correspond to different rows of pixels respectively; and
each of the gate driving unit groups includes a plurality of gate driving units coupled to a plurality of rows of sub-pixels in a corresponding row of pixels in one-to-one correspondence, and the plurality of gate driving unit groups are coupled to the plurality of groups of first clock lines in one-to-one correspondence.

Optionally, the plurality of gate driving units included in each of the gate driving circuits are coupled to eight first clock lines, the eight first clock lines are divided into four groups of first clock lines, and each group of first clock lines include two first clock lines;
each of the pixels includes three sub-pixels which are arranged in the pixel column direction and have different colors; each of the gate driving sub-circuits includes: four gate driving unit groups in a one-to-one correspondence with four rows of pixels; and each of the gate driving unit groups includes three gate driving units which are coupled to three rows of sub-pixels in a corresponding row of pixels in one-to-one correspondence.

Optionally, the gate driving circuit group includes two gate driving circuits arranged sequentially in the pixel row direction;
the plurality of gate driving units included in one gate driving circuit are coupled to a plurality of odd rows of sub-pixels through a plurality of first output lines in one-to-one correspondence; and the plurality of gate driving units included in the other gate driving circuit are coupled to a plurality of even rows of sub-pixels through a plurality of first output lines in one-to-one correspondence.

Optionally, the substrate includes a plurality of display partitions arranged sequentially along the pixel column direction, wherein each of the display partition includes at least two rows of pixels; and
the driving circuit includes a plurality of gate driving circuit groups which are in one-to-one correspondence with the plurality of display partitions and arranged sequentially along the pixel column direction.

Optionally, the driving circuit further includes a dummy driving circuit group disposed in at least one display partition, wherein the dummy driving circuit group includes dummy circuits corresponding to the gate driving circuits respectively, and the dummy circuit includes a plurality of dummy units, wherein
in the plurality of dummy units, one part of dummy units is disposed at a side, away from the gate driving unit coupled to a last row of sub-pixels, of the gate driving unit coupled to a first row of sub-pixels in a corresponding gate driving circuit, and is cascade-connected sequentially along the pixel column direction; and the other part of dummy units is disposed at a side, away from the gate driving unit coupled to a first row of sub-pixels, of the gate driving unit coupled to a last row of sub-pixels in a corresponding gate driving circuit, and is cascade-connected sequentially along the pixel column direction.

Optionally, the number of the plurality of dummy units is the same as the number of the plurality of first clock lines, and in the plurality of dummy units, the number of one part of dummy units is the same as the number of the other part of dummy units.

Optionally, each of the light emission driving units includes an input sub-circuit and an output sub-circuit, wherein
the input sub-circuit is coupled to the second start line, the second clock line and a control node respectively, and is configured to control a potential of the control node based on the second start signal and the second clock signal;
the output sub-circuit is coupled to the control node and the second output line respectively, and is configured to transmit a light emission driving signal to the second output line based on the potential of the control node; and
at least two light emission driving units share the same input sub-circuit.

Optionally, the plurality of light emission driving units is divided into a plurality of light emission driving unit groups, and each of the light emission driving units group includes four adjacent light emission driving units which are coupled to sub-pixels of the same color; and
the four adjacent light emission driving units in each of the light emission driving units group share the same input sub-circuit.

Optionally, the substrate includes a plurality of display partitions arranged sequentially along the pixel column direction, wherein each of the display partition includes at least two rows of pixels;
the plurality of second clock lines is divided into a plurality of groups of second clock lines, wherein each group of second clock lines include at least two second clock lines; and the light emission driving units coupled to the at least two rows of pixels in one display partition are coupled to one group of second clock lines, and the light emission driving units coupled to the at least two rows of pixels in adjacent display partitions are coupled to different groups of second clock lines.

Optionally, the plurality of light emission driving units included in each of the light emission driving circuits are coupled to four second clock lines, the four second clock lines are divided into two groups of second clock lines, and each group of second clock lines include two second clock lines; and
the light emission driving units coupled to the at least two rows of pixels in odd display partitions are coupled to one group of second clock lines in two groups of second clock lines, and the light emission driving units coupled to the at least two rows of pixels in even display partitions are coupled to the other group of second clock lines in two groups of second clock lines.

Optionally, the first start line, the first clock line, the second start line and the second clock line are alternating-current driving lines;
each of the gate driving units and each of the light emission driving units are further coupled to a direct-current driving line, each of the gate driving units is configured to transmit a gate driving signal to the coupled first output line based on the first start signal, the first clock signal, and a driving signal provided by the coupled direct-current driving line, and each of the light emission driving units is configured to transmit a light emission driving signal to the coupled second output line based on the second start signal, the second clock signal, and a driving signal provided by the coupled direct-current driving line; and
for each driving circuit in the gate driving circuit and the light emission driving circuit, the coupled direct-current driving lines are disposed at two sides of the driving circuit in the pixel row direction, and the alternating-current driving lines coupled to each driving circuit are disposed at sides of the direct-current driving lines away from the driving circuit.

Optionally, the pixel includes a gate metal layer, a first insulating layer, a first source-drain metal layer, a second insulating layer and a second source-drain metal layer which are sequentially stacked in a direction away from the substrate; and
the first output lines and the second output lines are disposed in the same layer as the second source-drain metal layer.

In another aspect, a display device is provided. The display device includes a display panel, and the driving circuit as defined in the above aspect, wherein
the display panel includes a substrate, and a plurality of pixels disposed on the substrate; the driving circuit is coupled to the plurality of pixels and is configured to transmit scanning driving signals and light emission driving signals to the plurality of pixels; and the plurality of pixels are configured to emit light based on the scanning driving signals and the light emission driving signals.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a structural schematic diagram of a display panel according to some embodiments of the present disclosure;

FIG. 2 is a structural schematic diagram of a driving circuit according to some embodiments of the present disclosure;

FIG. 3 is a schematic diagram of a circuit structure of a sub-pixel according to some embodiments of the present disclosure;

FIG. 4 is a structural schematic diagram of another driving circuit according to some embodiments of the present disclosure;

FIG. S is a schematic diagram of a cascade-connection relationship of a gate driving circuit according to some embodiments of the present disclosure;

FIG. 6 is a schematic diagram of a cascade-connection relationship of another gate driving circuit according to some embodiments of the present disclosure;

FIG. 7 is a schematic diagram of a circuit structure of a gate driving unit according to some embodiments of the present disclosure;

FIG. 8 is a structural schematic diagram of a display panel and a gate driving circuit according to some embodiments of the present disclosure;

FIG. 9 is a structural schematic diagram of a light emission driving unit according to some embodiments of the present disclosure;

FIG. 10 is a schematic diagram of a cascade-connection relationship of a light emission control circuit according to some embodiments of the present disclosure;

FIG. 11 is a schematic diagram of a cascade-connection relationship of a reset driving circuit and a compensation driving circuit according to some embodiments of the present disclosure;

FIG. 12 is a schematic diagram of a circuit structure of a light emission driving unit in the light emission control circuit according to some embodiments of the present disclosure;

FIG. 13 is a schematic diagram of a circuit structure of a light emission driving unit in the reset driving circuit and the compensation driving circuit according to some embodiments of the present disclosure;

FIG. 14 is a structure layout of the gate driving circuit according to some embodiments of the present disclosure;

FIG. 15 is a structure layout of the light emission control circuit according to some embodiments of the present disclosure;

FIG. 16 is a structure layout of the reset driving circuit and the compensation driving circuit according to some embodiments of the present disclosure;

FIG. 17 is a structure layout of the driving circuit according to some embodiments of the present disclosure;

FIG. 18 is a structural schematic diagram of a display panel and a driving circuit according to some embodiments of the present disclosure;

FIG. 19 is a sequence diagram of a working signal of the sub-pixel according to some embodiments of the present disclosure;

FIG. 20 is a sequence diagram of a working signal of the driving circuit according to some embodiments of the present disclosure; and

FIG. 21 is a simulation diagram of the working signal of the driving circuit according to some embodiments of the present disclosure; and

FIG. 22 is a structural schematic diagram of a display device according to some embodiments of the present disclosure.

### DETAILED DESCRIPTION

For clearer descriptions of the objectives, technical solutions and advantages in the present disclosure, the embodiments of the present disclosure are described in further detail below with reference to the accompanying drawings.

It should be noted that transistors used in all embodiments of the present disclosure may be thin film transistors, field-effect transistors or other devices having the same properties, and are mainly switching transistors according to their functions in a circuit. Since a source and a drain of the switching transistor used here are symmetrical, the source and the drain of the switching transistor are interchangeable. In the embodiments of the present disclosure, the source is referred to as a first electrode and the drain is referred to as a second electrode. According to the form in the figure, it is specified that for the transistor, a middle terminal is a control electrode, which may also be referred to as a gate, a signal input terminal is the source, and a signal output terminal is the drain. In addition, the switching transistors used in the embodiments of the present disclosure may include either P-type switching transistors or N-type switching transistors. The P-type switching transistor is turned on when the gate is at a low level and is turned off when the gate is at a high level, and the N-type switching transistor is turned on when the gate is at the high level and is turned off when the gate is at the low level. In addition, a plurality of signals in various embodiments of the present disclosure each correspond to a first potential and a second potential. The first potential and the second potential only represent that the potential of the signal has two state quantities, instead of representing that the first potential or the second potential in the whole text has a specific value.

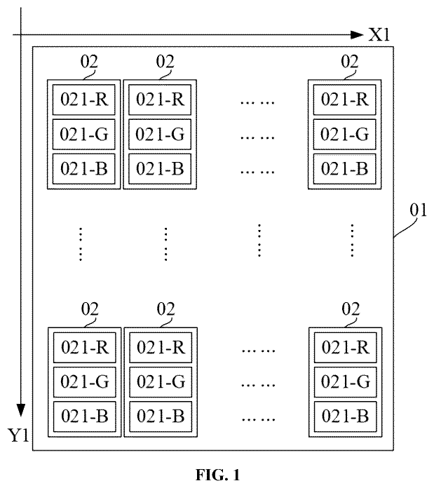

Embodiments of the present disclosure provide a driving circuit of a display panel. Firstly, referring to FIG. 1, it can be seen that the display panel provided by the embodiments of the present disclosure includes a substrate 01, and a plurality of pixels 02 disposed on the substrate 01 and arranged in an array, i.e., a plurality of rows and a plurality of columns of pixels 02. each of the pixels 02 includes a plurality of sub-pixels 021 which are arranged along a pixel column direction Y1 and have different colors, that is, the display panel includes a plurality of rows of sub-pixels 021.

For example, in the display panel shown in FIG. 1, each of the pixels 02 may include three sub-pixels 021, i.e., a red sub-pixel 021-R, a green sub-pixel 021-G, and a blue sub-pixel 021-B. It can be seen therefrom that compared with a conventional display panel that each of the pixels only includes one row of sub-pixels, the display panel 00 provided by the embodiments of the present disclosure includes more rows of sub-pixels, and belongs to a display panel with high PPI (pixels per inch), where the PPI refers to the number of sub-pixels per inch in the substrate 01. The display panel having the structure shown in FIG. 1 is often used in three-dimensional (3D) display devices, such as 3D glasses.

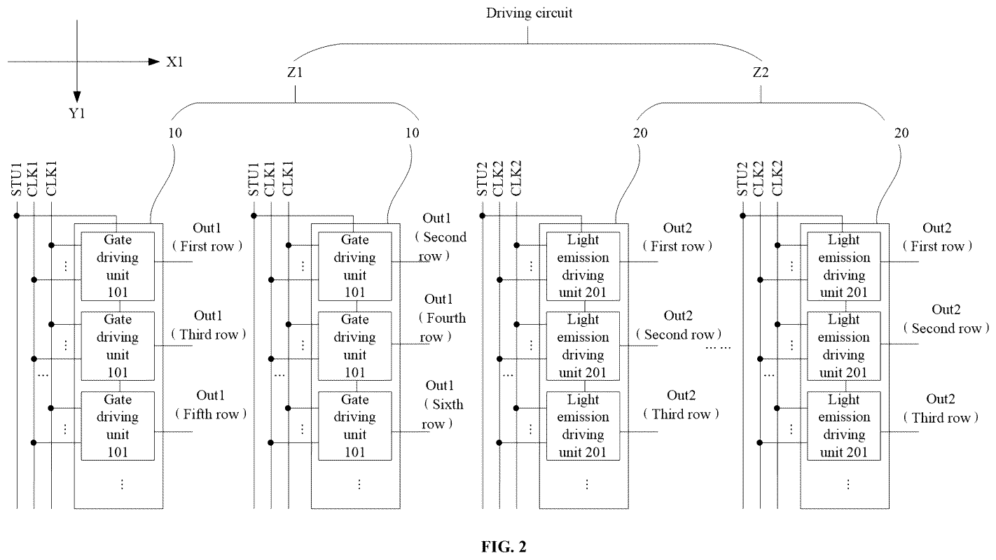

Next, referring to FIG. 2, the driving circuit provided by the embodiments of the present disclosure includes a gate driving circuit group Z1 and a light emission driving circuit group Z2 which are arranged sequentially along a pixel row direction X1.

The gate driving circuit group Z1 includes a plurality of gate driving circuits 10 arranged sequentially along the pixel row direction X1. Each of the gate driving circuits 10 includes a plurality of gate driving units 101 cascade-connected along a pixel column direction Y1.

The light emission driving circuit group Z2 includes a plurality of light emission driving circuits 20 arranged sequentially along the pixel row direction X1. Each of the light emission driving circuits 20 includes a plurality of light emission driving units 201 cascade-connected along the pixel column direction Y1.

The plurality of gate driving units 101 included in the plurality of gate driving circuits 10 are coupled to a plurality of rows of sub-pixels 021 through a plurality of first output lines Out1, the plurality of gate driving units 101 included in each of the gate driving circuits 10 are also coupled to a first start line STU1 and a plurality of first clock lines CLK1 respectively, and the first output lines Out1, the first start lines STU1 and the first clock lines CLK1 coupled to the plurality of gate driving units 101 included the various gate driving circuits 10 are different. That is, the plurality of gate driving units 101 included in each of the gate driving circuits 10 may be coupled to a plurality of rows of sub-pixels 021 in all rows of sub-pixels 021. The various gate driving circuits 10 may be coupled to different rows of sub-pixels 021. For example, assuming that the display panel includes n rows of sub-pixels 021 in total, n being an integer greater than 0, and the gate driving circuit group Z1 includes two gate driving circuits 10 as shown in FIG. 2, the plurality of gate driving units 101 in one gate driving circuit 10 may be coupled to (n−i) rows of sub-pixels 021 in the n rows of sub-pixels 021, the plurality of gate driving units 101 in the other gate driving circuit 10 may be coupled to the remaining rows of sub-pixels 021 except (n−i) rows sub-pixels 021 in the n rows of sub-pixels 021, where i may be an integer less than or equal to n. In addition, the plurality of gate driving units 101 in each of the gate driving circuits 10 may be coupled to the plurality of rows of sub-pixels 021 in one-to-one correspondence, as shown in FIG. 2. In this way, for the display panel with ultra-high PPI (i.e., including a large number of rows of sub-pixels) shown in FIG. 1, a plurality of independent gate driving circuits 10 may be arranged along the pixel row direction X1 so as to be coupled to a plurality of different rows of sub-pixels 021 respectively, and compared with the related art in which a large number of gate driving units are arranged in the pixel column direction Y1 only at present, this can be conductive to layout arrangement and can ensure reliable driving for a larger number of rows of sub-pixels 021.

The plurality of light emission driving units 201 included in each of the light emission driving circuits 20 are coupled to the plurality of rows of sub-pixels 021 through a plurality of second output lines Out2, the plurality of light emission driving units 201 included in each of the light emission driving circuits 20 are also coupled to a second start line STU2 and a plurality of second clock lines CLK2 respectively, and the second output lines Out2, the second start lines STU2 and the second clock lines CLK2 coupled to the plurality of light emission driving units 201 included in the various light emission driving circuits 20 are different. That is, also assuming that the display panel includes n rows of sub-pixels 021 in total, the plurality of light emission driving units 201 included in each of the light emission driving circuits 20 may be coupled to the n rows of sub-pixels 021. In addition, the plurality of light emission driving units 201 in each of the light emission driving circuits 20 may be coupled to the plurality of rows of sub-pixels in one-to-one correspondence, as shown in FIG. 2.

On the basis of the above coupling, the plurality of gate driving units 101 included in each of the gate driving circuits 10 are configured to transmit gate driving signals to the coupled first output lines Out1 based on a first start signal provided by the coupled first start line STU1 and first clock signals provided by the coupled first clock lines, that is, transmit gate driving signals to the plurality of rows of sub-pixels 021 through the first output lines Out1. Correspondingly, the first output lines Out1 may also be referred to as gate lines. The plurality of light emission driving units 201 included in each of the light emission driving circuits 20 are configured to transmit light emission driving signals to the coupled second output lines Out2 based on a second start signal provided by the coupled second start line STU2 and second clock signals provided by the coupled second clock lines CLK2, that is, transmit light emission driving signals to the plurality of rows of sub-pixels 021 through the second output lines Out2. The plurality of rows of sub-pixels 021 may be configured to emit light based on the received gate driving signals and light emission driving signals.

In summary, the embodiments of the present disclosure provide the driving circuit of the display panel. The driving circuit includes the gate driving circuit group and the light emission driving circuit group which are arranged sequentially along the pixel row direction. The gate driving circuit group includes the plurality of gate driving circuits arranged sequentially along the pixel row direction and the light emission driving circuit group includes the plurality of light emission driving circuits arranged sequentially along the pixel row direction. Each of the gate driving circuits includes the plurality of gate driving units cascade-connected along the pixel column direction. Each of the light emission driving circuits includes the plurality of light emission driving circuits cascade-connected along the pixel column direction. The gate driving circuit is configured to transmit the gate driving signals to the plurality of rows of sub-pixels. The light emission driving circuit is configured to transmit the light emission driving signals to the plurality of rows of sub-pixels to drive the plurality of rows of sub-pixels to emit light. In this way, for the display panel with relatively high resolution (i.e., including a large number of rows of sub-pixels), a plurality of driving circuits can be arranged along the pixel row direction to drive the sub-pixels to emit light, which is conductive to layout arrangement.

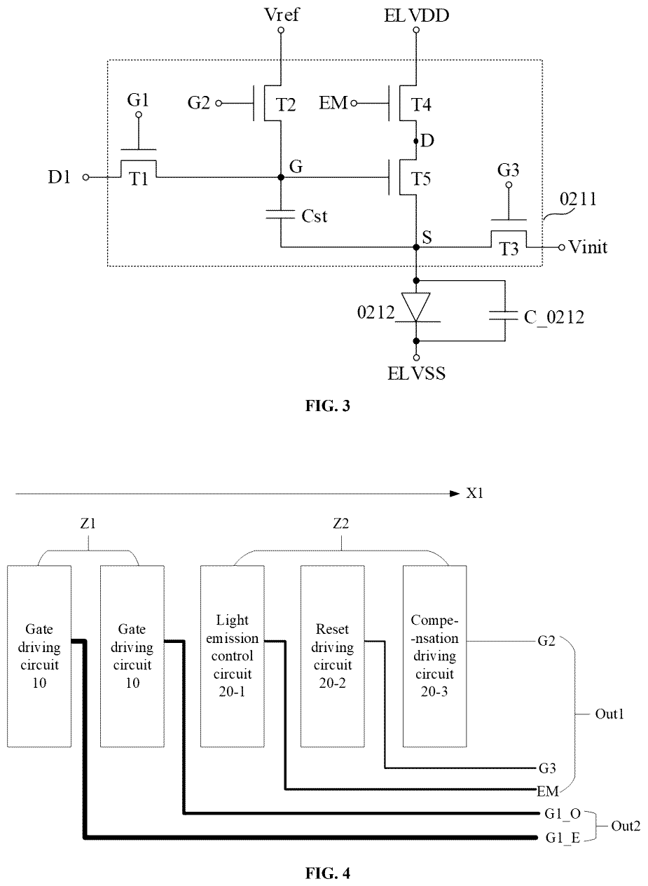

Optionally, the light emission driving signal described in the embodiments of the present disclosure may include at least one of a light emission control signal, a reset signal and a compensation signal. Referring to FIG. 3, which shows a structural schematic diagram of a sub-pixel 021 by taking a red sub-pixel 021 shown in FIG. 1 as an example, the sub-pixel 021 not only receives the gate driving signal, but also receives the light emission control signal, the reset signal and the compensation signal. On this basis, referring to FIG. 3, it can be seen that each sub-pixel 021 may include a pixel circuit 0211 and a light-emitting element 0212.

Optionally, the pixel circuit 0211 may be a circuit of a 5T1C (i.e., including five transistors and one capacitor) structure. Referring to FIG. 3, these five transistors may include a data writing transistor T1, a compensation transistor T2, a reset transistor T3, a light emission control transistor T4 and a driving transistor T5, and the one capacitor may include a storage capacitor Cst.

A gate of the data writing transistor T1 may be coupled to a gate line G1 (i.e., the first output line Out1 described in the above embodiment), a first electrode of the data writing transistor T1 may be coupled to a data line Data, and a second electrode of the data writing transistor T1 may be coupled to a gate (i.e., a G node) of the driving transistor T5. The data writing transistor T1 may be turned on or off based on the gate driving signal provided by the gate line G1, so that the data line Data is conducted with or decoupled from the gate of the driving transistor T5.

For example, when a potential of the gate driving signal provided by the gate line G1 is a first potential, the data writing transistor T1 may be turned on, and correspondingly the data line Data may be conducted with the gate of the driving transistor T5 and thus may transmit a data signal to the gate of the driving transistor T5. When the potential of the gate driving signal provided by the gate line G1 is a second potential, the data writing transistor T1 may be turned off, and correspondingly the data line Data may be decoupled from the gate of the driving transistor T5.

Optionally, in the embodiments of the present disclosure, the first potential may be an effective potential, and the second potential may be an ineffective potential; when the transistor is an N-type transistor, the first potential may be a high potential relative to the second potential; and when the transistor is a P-type transistor, the first potential may be a low potential relative to the second potential.

A gate of the compensation transistor T2 may be coupled to a compensation line G2, a first electrode of the compensation transistor T2 may be coupled to a reference signal line Vref, and a second electrode of the compensation transistor T2 may be coupled to the gate of the driving transistor T5. The compensation transistor G2 may be turned on or off based on a compensation signal provided by the compensation line G2, so that the reference signal line Vref is conducted with or decoupled from the gate of the driving transistor T5.

For example, when a potential of the compensation signal provided by the compensation line G2 is a first potential, the compensation transistor G2 may be turned on, and correspondingly the reference signal line Vref may be conducted with the gate of the driving transistor T5 and thus may transmit a reference signal to the gate of the driving transistor T5. When the potential of the compensation signal provided by the compensation line G2 is a second potential, the compensation transistor G2 may be turned off, and correspondingly the reference signal line Vref may be decoupled from the gate of the driving transistor T5.

A gate of the reset transistor T3 may be coupled to a reset line G3, a first electrode of the reset transistor T3 may be coupled to an initial power supply line Vinit, and a second electrode of the reset transistor T3 may be coupled to a second electrode (i.e., an S node) of the driving transistor T5. The reset transistor T3 may be turned on or off based on a reset signal provided by the reset line G3, so that the initial power supply line Vinit is conducted with or decoupled from the second electrode of the driving transistor T5.

For example, when a potential of the reset signal provided by the reset line G3 is a first potential, the reset transistor T3 may be turned on, and correspondingly the initial power supply line Vinit may be conducted with the second electrode of the driving transistor T5 and thus may transmit an initial power supply signal to the second electrode of the driving transistor T5. When the potential of the reset signal provided by the reset line G3 is a second potential, the reset transistor G3 may be turned off, and correspondingly the initial power supply line Vinit may be decoupled from the second electrode of the driving transistor T5.

A gate of the light emission control transistor T4 may be coupled to a light emission control line EM, a first electrode of the light emission control transistor T4 may be coupled to a charging power supply line ELVDD, and a second electrode of the light emission control transistor T4 may be coupled to a first electrode (i.e., a D node) of the driving transistor T5. The light emission control transistor T4 may be turned on or off based on a light emission control signal provided by the light emission control line EM, so that the charging power supply line ELVDD is conducted with or decoupled from the first electrode of the driving transistor T5.

For example, when a potential of the light emission control signal provided by the light emission control line EM is a first potential, the light emission control transistor T4 may be turned on, and correspondingly the charging power supply line ELVDD may be conducted with the first electrode of the driving transistor T5 and thus may transmit a charging power supply signal to the first electrode of the driving transistor T5. When the potential of the light emission control signal provided by the light emission control line EM is a second potential, the light emission control transistor T4 may be turned off, and correspondingly the charging power supply line EL VDD may be decoupled from the first electrode of the driving transistor T5.

The second electrode of the driving transistor T5 may also be coupled to a first electrode of the light-emitting element 0212. The driving transistor T5 may transmit a light emission driving signal (such as a driving current) to the second electrode (i.e., the first electrode of the light-emitting element 0212) based on a potential of the gate thereof and a potential of the first electrode thereof. A second electrode of the light-emitting element 0212 may further be coupled to a pull-down power supply line ELVSS. The light-emitting element 0212 may emit light based on the light emission driving signal and a pull-down power supply signal provided by the pull-down power supply line ELVSS. For example, the light-emitting element 0212 may emit light under the action of a voltage difference between the light emission driving signal and the pull-down power supply signal.

Optionally, the first electrode of the light-emitting element 0212 may be an anode, and the second electrode of the light-emitting element 0212 may be a cathode. Certainly, in some other embodiments, the first electrode of the light-emitting element 0212 may also be a cathode, and correspondingly, the second electrode of the light-emitting element 0212 may be an anode.

One terminal of the storage capacitor Cst may be coupled to the gate of the driving transistor T5, and the other terminal of the storage capacitor Cst may be coupled to the second electrode of the driving transistor T5. The storage capacitor Cst may be configured to adjust the potential of the gate of the driving transistor T5 based on the potential of the second electrode of the driving transistor T5.

In addition, FIG. 3 also schematically shows parasitic capacitance C_0212 formed between the anode and cathode of the light-emitting element 0212. It should be noted that in some embodiments, the pixel circuit included in the sub-pixel 021 is not limited to the 5T1C structure shown in the figure, and may, for example, also be a 6T2C structure.

On the basis of FIG. 3, in order to generate the three light emission driving signals, i.e., the light emission control signal, the reset signal and the compensation signal, continuously referring to the driving circuit shown in FIG. 4, it can be seen that the light emission driving circuit group Z2 described in the embodiments of the present disclosure may include three light emission driving circuits 20: a light emission driving circuit (which may be referred to as a light emission control circuit) for generating the light emission control signal, a light emission driving circuit (which may be referred to as a reset driving circuit) for generating the reset signal and a light emission driving circuit (which may be referred to as a compensation driving circuit) for generating the compensation signal. In the figure, for distinguishing, the light emission control circuit is marked as 20-1, the reset driving circuit is marked as 20-2, and the compensation driving circuit is marked as 20-3. In conjunction with FIG. 3, it can also be seen that in the embodiments of the present disclosure, the second output line Out2 that transmits the light emission control signal may also be referred to as the light emission control line EM; the second output line Out2 that transmits the reset signal may also be referred to as the reset line G3; and the second output line Out2 that transmits the compensation signal may be referred to as the compensation line G2.

The light emission driving unit included in the light emission control circuit 20-1 may be coupled to the gate of the light emission control transistor T4 through the second output line Out2, i.e., the light emission control line EM shown in FIG. 3, and is configured to transmit the light emission control signal to the light emission control line EM. The light emission driving unit included in the reset driving circuit 20-2 may be coupled to the gate of the reset transistor T3 through the second output line Out2, i.e., the reset line G3 shown in FIG. 3, and configured to transmit the reset signal to the reset line G3. The light emission driving unit included in the compensation driving circuit 20-3 may be coupled to the gate of the compensation transistor T2 through the second output line Out2, i.e., the compensation line G2 shown in FIG. 3, and configured to transmit the compensation signal to the compensation line G2. The gate driving unit may be coupled to the gate of the data writing transistor T1 through the gate line G1 shown in FIG. 3, and configured to transmit the gate driving signal to the gate line G1. Correspondingly, as described in the above embodiments, the gate line G1 is the first output line Out1, and the compensation line G2, the reset line G3 and the light emission control line EM are all the second output lines Out2.

It should be noted that in the driving circuit described in the embodiments of the present disclosure, both the gate driving circuit 10 and the light emission driving circuit 20 may both be integrated on the display panel using the gate driver on array (GOA) technology. Correspondingly, the gate driving circuit 10 and the light emission driving circuit 20 may both be referred to as GOA circuits and the gate driving unit 101 and the light emission driving unit 201 may both be referred to as GOA units. In the following embodiments of the present disclosure, the gate driving circuit and the gate driving units included therein are marked as “Gate GOA”; the light emission control circuit and the light emission driving units included therein are marked as “EM GOA”; and the reset driving circuit and the compensation driving circuit are both marked as “PWM GOA” because the reset signal and the compensation signal are generally pulse width modulation (PWM) signals. The Gate GOA, the EM GOA and the PWM GOA are three types of GOAs provided by the embodiments of the present disclosure.

Optionally, continuously referring to FIG. 2 and FIG. 4, it can be seen that the gate driving circuit group Z1 provided by the embodiments of the present disclosure may include two gate driving circuits 10 arranged sequentially in the pixel row direction X1.

In the two gate driving circuits 10, the plurality of gate driving units 101 included in one gate driving circuit 10 may be coupled to a plurality of odd rows (i.e., a first row, a third row, a fifth row . . . ) of sub-pixels 021 through a plurality of first output lines Out1 in one-to-one correspondence. A plurality of gate driving units 101 included in the other gate driving circuit 10 may be coupled to a plurality of even rows (i.e., a second row, a fourth row, a sixth row . . . ) of sub-pixels 021 through a plurality of first output lines Out1 in one-to-one correspondence. Correspondingly, in conjunction with FIG. 4, the plurality of first output lines Out1 coupled to the plurality of even rows of sub-pixels 021 in one-to-one correspondence may be marked as gate lines G1_E; and the plurality of first output lines Out1 coupled to the plurality of odd rows of sub-pixels 021 in one-to-one correspondence may be marked as gate lines G1_O.

That is, in the embodiments of the present disclosure, for the plurality of rows of sub-pixels 021 in the display panel, two gate driving circuits 10, which are correspondingly coupled to odd rows of sub-pixels 021 and even rows of sub-pixels 021 respectively, and arranged sequentially along the pixel row direction X1, may be disposed. In this way, for the display panel with ultra-high PPI, it can be ensured that the gate driving signals are reliably transmitted to a large number of rows of sub-pixels 021 within a limited layout space of the display panel. Certainly, in some other embodiments, more gate driving circuits 10 arranged sequentially along the pixel row direction X1 may be disposed. The embodiments of the present disclosure do not limit the number of gate driving circuits 10 arranged.

Optionally, in conjunction with FIG. 4, it can also be seen that in the embodiments of the present disclosure, the plurality of gate driving circuits 10, the light emission control circuit 20-1, the reset driving circuit 20-2 and the compensation driving circuit 20-3 may be arranged sequentially in a direction approaching to the pixels 02 along the pixel row direction X1. In addition, in the two gate driving circuits 10 shown in FIG. 4, the gate driving circuit 10 coupled to the plurality of even rows of sub-pixels 021 (that is, coupled to the gate line G1_E) and the gate driving circuits 10 coupled to the plurality of odd rows of sub-pixels 021 (that is, coupled to the gate line G1_O) may be arranged sequentially in the direction approaching to the pixels 02. That is, referring to FIG. 4, in the pixel row direction XI, the gate driving circuit 10 coupled to the gate line G1-E, the gate driving circuit 10 coupled to the gate line G1-O, the light emission control circuit 20-1, the reset driving circuit 20-2, and the compensation driving circuit 20-3 are arranged sequentially from left to right, gradually approaching the pixels 02.

It can be seen from FIG. 4 that at the position of the rightmost circuit (i.e., the compensation driving circuit 20-3), wiring space for at least 5 lines needs to be reserved for the arrangement of the gate lines G1 (including G1_O and G1_E), the compensation line G2, the reset line G3, and the light emission control line EM; and at the position of the leftmost circuit (i.e., the plurality of gate driving circuits 10), there is no need to reserve wiring space, and accordingly, the arrangement space is relatively large. Comprehensively considering these two factors, by disposing the plurality of gate driving circuits 10, the light emission control circuit 20-1, the reset driving circuit 20-2 and the compensation driving circuit 20-3 according to the arrangement shown in FIG. 4, the arrangement space can be fully used. In addition, because the gate driving signal is particularly important relative to other signals (such as the light emission control signal) and is related to the writing of the data signal, by disposing the gate driving circuits 10 at the outermost side away from pixels 02, the other signals in the pixels 02 can be prevented from interfering with the operation of the gate driving circuits 10, that is, it is ensured that the gate driving signals are reliably generated.

Optionally, in the embodiments of the present disclosure, the plurality of first clock lines CLK1 may be divided into a plurality of groups of first clock lines CLK1, and each group of first clock lines CLK1 include at least two first clock lines CLK1.

Each of the gate driving circuits 10 may include a plurality of gate driving sub-circuits 100. Each of the gate driving sub-circuits 100 may be coupled to the plurality of groups of first clock lines CLK1 and includes a plurality of gate driving unit groups Z3 in one-to-one correspondence with the plurality of rows of pixels 02, and the various gate driving sub-circuits 100 correspond to different rows of pixels 02 respectively. Each of the gate driving unit groups Z3 includes a plurality of gate driving units 101 coupled to a plurality of rows of sub-pixels 021 in a corresponding row of pixels 02 in one-to-one correspondence, and the plurality of gate driving unit groups Z3 are coupled to the plurality of groups of first clock lines CLK1 in one-to-one correspondence.

For example, on the basis of FIG. 4, FIG. 5 shows a structural schematic diagram of a gate driving circuit. As shown in FIG. 5, the plurality of gate driving units 101 included in each of the gate driving circuits 10 may be coupled to eight first clock lines CLK1, the eight first clock lines CLK1 may be divided into four groups of first clock lines CLK1, and each group of first clock lines CLK1 may include two first clock lines CLK1.

In addition, in conjunction with FIGS. 1 and 5, each of the pixels 02 may include three sub-pixels 021 which are arranged along the pixel column direction Y1 and have different colors. The three sub-pixels 021 may include a red sub-pixel 02-R, a green sub-pixel 02-G, and a blue sub-pixel 02-B as described in the above embodiments.

Each of the gate driving sub-circuits 100 may include four gate driving unit groups Z3 in one-to-one correspondence with four rows of pixels 02. Each of the gate driving unit groups Z3 may include three gate driving units 101 coupled to three rows of sub-pixels 021 in one row of pixels 02 in one-to-one correspondence. That is, referring to FIG. 5, each of the two gate driving circuits 10 shown in FIG. 5 may be coupled to eight first clock lines CLK1. Each of the gate driving units 101 in each of the gate driving circuits 10 may be coupled to two first clock lines CLK1. Each of the gate driving units 101 is coupled to a row of sub-pixels 021, and three gate driving units 101 coupled to three sub-pixels 021 in the same pixel 02 are coupled to the same two first clock lines CLK1. Correspondingly, it can be seen that four groups of gate driving units, i.e., 12 gate driving units, in one gate driving circuit 10 may be coupled to four groups of first clock lines CLK1, i.e., eight first clock lines CLK1, and 12 rows of sub-pixels, respectively. On the basis of disposing two gate driving circuits 10 according to odd rows and even rows, it can be seen that by taking a total of 24 rows of sub-pixels 021, i.e., 12 odd rows of sub-pixel 021 and 12 even rows of sub-pixels 021, as a repeat unit, each of the gate driving circuits 10 is disposed to be coupled to the plurality of first clock lines CLK1.

Optionally, referring to FIG. 5, in the embodiments of the present disclosure, the eight first clock lines CLK1 coupled to the gate driving circuit 10 corresponding to the odd rows of sub-pixels 021 may be referred to as odd clock lines, and are marked as CLK1-1, CLK1-3, CLK1-5, CLK1-7, CLK1-9, CLK1-11, CLK1-13 and CLK1-15; and the eight first clock lines CLK1 coupled to the gate driving circuit 10 corresponding to the even rows of sub-pixels 021 are referred to as even clock lines, and are marked as CLK1-2, CLK1-4, CLK1-6, CLK1-8, CLK1-10, CLK1-12, CLK1-14 and CLK1-16. That is, the gate driving circuit group Z1 described in the embodiments of the present disclosure may be coupled to 16 first clock lines CLK1.

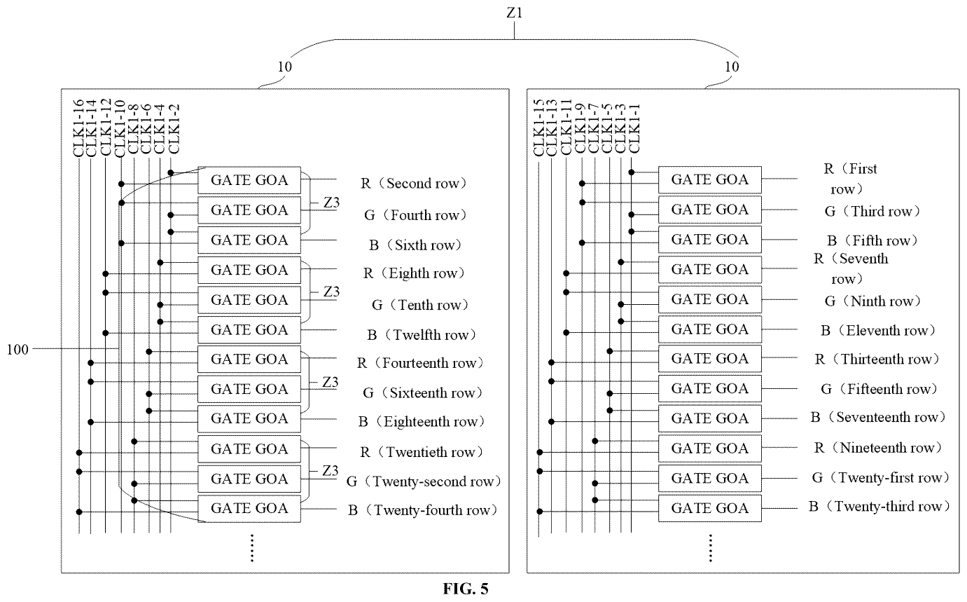

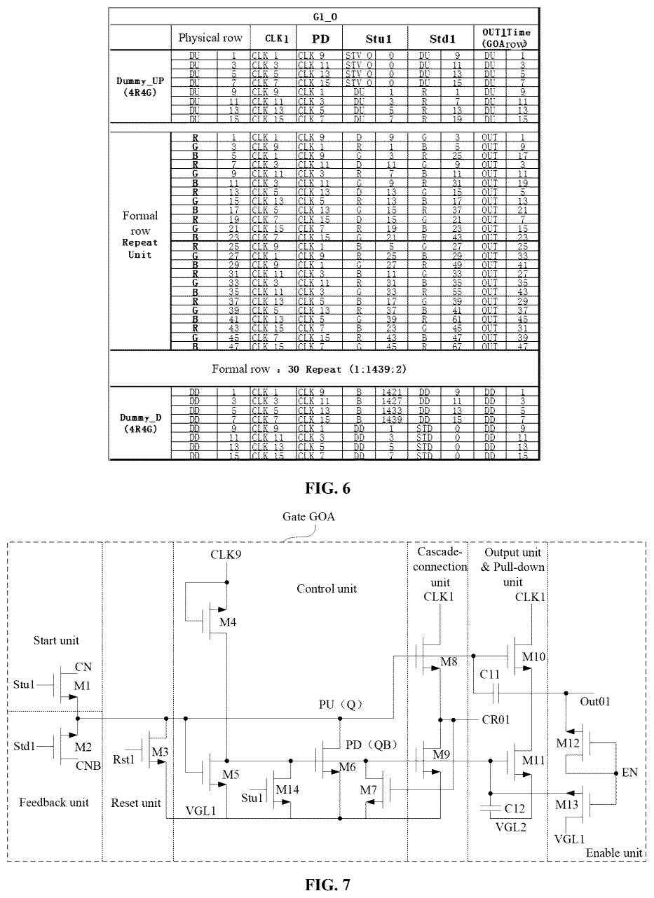

Optionally, by taking odd rows of sub-pixels 021 as an example, FIG. 6 shows a cascade-connection look-up table of a gate driving circuit. In FIG. 6, the first clock lines are directly marked as “CLK”. On the basis of the coupling to the first clock lines CLK1, in conjunction with a diagram of a circuit structure of a gate driving unit (i.e., Gate GOA) shown in FIG. 7, it can be seen that in the plurality of cascade-connected gate driving units 101 described in the embodiments of the present disclosure, an N^{th} gate driving unit 101 may be cascade-connected to a (N+8)^{th} gate driving unit 101, where N may be a positive integer. An input terminal Stu1 of the N^{th} gate driving unit 101 may be coupled to an output terminal of a (N−8)^{th} gate driving unit 101, and a reset terminal Std1 of the N^{th} gate driving unit 101 may be coupled to an output terminal of the (N+8)^{th} gate driving unit 101. It should be noted that on the basis of including an output terminal OUT01 for transmitting the gate driving signal and an output terminal CR01 for cascade-connection as shown in FIG. 7, the output terminal here may refer to the cascade-connected output terminal CR01. If CR01 represents a cascade-connection signal, Stu1<N>=CR01<N−8>; and Std1<N>=CR01<N+8>.

Optionally, referring to FIG. 7, it can further be seen that the gate driving unit 101 described in the embodiments of the present disclosure may be of a 14T2C structure, including 14 transistors (marked as M1 to M14 respectively) and 2 capacitors (marked as C11 and C12 respectively). In addition, the 14 transistors may be divided into units as follows: a start unit including a transistor M1; a feedback unit including a transistor M2; a reset unit including a transistor M3; a control unit including transistors M4 to M8, wherein nodes here include a pull-up node PU (which may also be marked as a Q node) and a pull-down node PD (which may also be marked as a QB node); a cascade-connection unit including transistors M9 and M10; and an output unit including transistors M11 to M14 as well as two capacitors C11 and C12. In addition, the gate driving unit of the 14T2C structure may also be coupled to a reset signal line Rst1, an enable signal line EN1, two control lines CN and CNB, and two direct-current (DC) power supply lines VGL1 and VGL2 in addition to the above terminals and signal lines. Signals provided by the two control lines CN and CNB, the two DC power supply lines VGL1 and VGL2, and the enable signal line ENI are generally DC signals. Signals provided by the first clock lines CLK1, the reset signal line Rst1 and the input terminal Stu1 are generally alternating-current (AC) signals.

Thus, on the basis of including 16 first clock lines CLK1, it can be seen that the gate driving circuit 10 described in the embodiments of the present disclosure may receive a total of twenty-four signals, including nineteen AC signals and five DC signals. The nineteen AC signals further include signals provided by sixteen first clock lines CLK1, signals provided by the reset signal lines Rst1 and a signal provided by the input terminal Stu1. The five DC signals include signals provided by the two DC power supply lines VGL1 and VGL2, a signal provided by the enable signal line ENI, and signals provided by the two control lines CN and CNB. Each of the gate driving units 101 can reliably generate the gate driving signal required for the sub-pixel 021 on the basis of the above signals received.

Certainly, the above embodiment is only an optional circuit structure of the gate driving unit, and in other embodiments, other structures (such as 16TIC) that can achieve the above functions may also be used as gate driving units.

Optionally, FIG. 8 shows a structural schematic diagram of another display panel and a driving circuit thereof. As shown in FIG. 8, the substrate 01 described in the embodiments of the present disclosure may include a plurality of display partitions AA arranged sequentially along the pixel column direction Y1. Each of the display partition AA may include at least two rows of pixels 02. The driving circuit may include a plurality of gate driving circuit groups Z1 which are in one-to-one correspondence with the plurality of display partitions AA and arranged sequentially along the pixel column direction Y1. For example, the display panel shown in FIG. 8 includes nine display partitions AA marked as display partitions AA-1 to AA-9 respectively. Correspondingly, the driving circuit may include nine gate driving circuit groups Z1. On the basis that each of the gate driving circuits group Z1 includes two gate driving circuits 10, it can be seen that the driving circuit may include eighteen gate driving circuits 10. In this way, it can be conducive to achieving local high-definition, medium-definition and low-definition display, and the display is controlled separately for the various display partitions AA, thereby achieving better display flexibility.

Optionally, on the basis of FIG. 8, in conjunction with FIG. 6 above, it can also be seen that the driving circuit described in the embodiments of the present disclosure may further include a dummy driving circuit group corresponding to at least one display partition AA. Each dummy driving circuit group may include dummy circuits corresponding to the gate driving circuits 10 respectively, and the dummy circuit may include a plurality of dummy units.

In the plurality of dummy units, one part of dummy units may be disposed at a side, away from the gate driving unit 101 coupled to a last row of sub-pixels 021, of the gate driving unit 101 coupled to a first row of sub-pixels 021 in the corresponding gate driving circuit 10 and is cascade-connected sequentially along the pixel column direction Y1; and the other part of dummy units is disposed at a side, away from the gate driving unit 101 coupled to a first row of sub-pixels 021, of the gate driving unit 101 coupled to a last row of sub-pixels 021 in the corresponding gate driving circuit 10, and is cascade-connected sequentially along the pixel column direction Y1.

For example, referring to FIG. 6, the number of the plurality of dummy units described in the embodiments of the present disclosure may be the same as the number of plurality of first clock lines CLK1, and in the plurality of dummy units, the number of one part of dummy units DU may be the same as the number of the other part of dummy units DD. That is, by taking that sixteen first clock lines are included as an example, eight dummy units DU and eight dummy units DD may be disposed at a side of the first row of sub-pixels and a side of the last row of sub-pixels respectively, that is, a total of sixteen dummy units may be disposed. In the related art, if twenty-four rows are used as a repeat unit, twenty-four dummy units need to be correspondingly disposed, and in the embodiments of the present disclosure, eight dummy units may be disposed at each of the side of the first row of sub-pixels and the side of the last row of sub-pixels only, so that the circuit can be prevented from occupying a larger number of rows, which is further conducive to layout arrangement.

It should be noted that the dummy unit is a circuit similar to the gate driving unit 101, and may have the same structure as the structure of the gate driving unit 101 except that the dummy unit is not coupled to the sub-pixel 021 and is not configured to transmit signals. Signal consistency can be ensured by disposing the dummy units. In FIG. 6, the plurality of dummy units DU disposed above the first row of sub-pixels 021 may be collectively referred to as Dummy UP and the plurality of dummy units DD disposed below the last row of sub-pixels 021 may be collectively referred to as Dummy D.

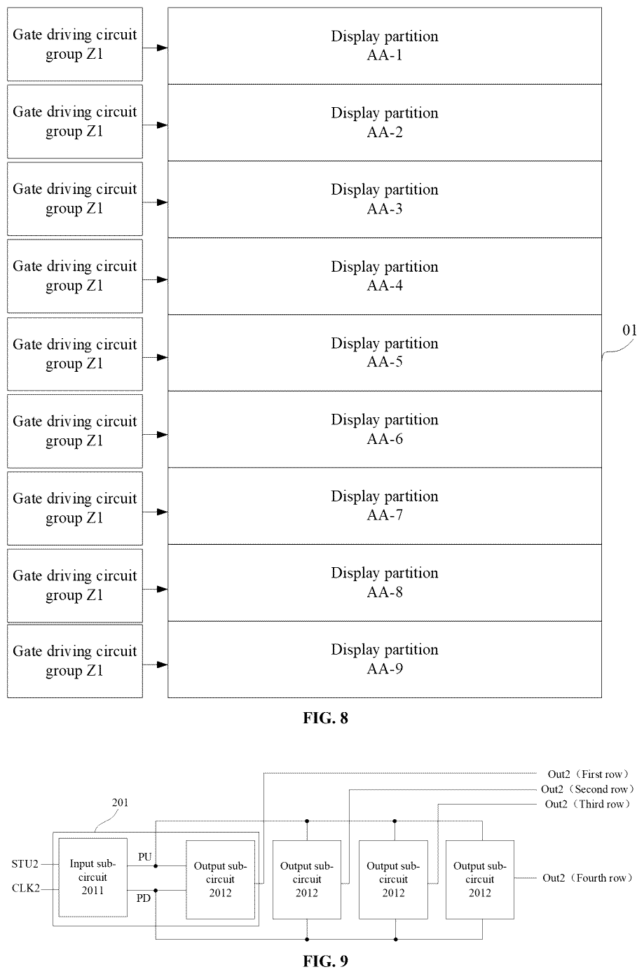

Optionally, FIG. 9 is a structural schematic diagram of a light emission driving unit according to some embodiments of the present disclosure. As shown in FIG. 9, each of the light emission driving units 201 may include an input sub-circuit 2011 and an output sub-circuit 2012.

The input sub-circuit 2011 may be coupled to the second start line STU2, the second clock line CLK2 and a control node respectively, and may be configured to control a potential of the control node based on the second start signal and the second clock signal. Optionally, the control node may include a pull-up node PU and a pull-down node PD.

The output sub-circuit 2012 may be coupled to the control node and the second output line Out2 respectively, and may be configured to transmit the light emission driving signal to the second output line Out2 based on the potential of the control node.

In the embodiments of the present disclosure, at least two light emission driving units 201 share the same input sub-circuit 2011. In this way, the circuit structure may be further simplified, which is conductive to layout arrangement.

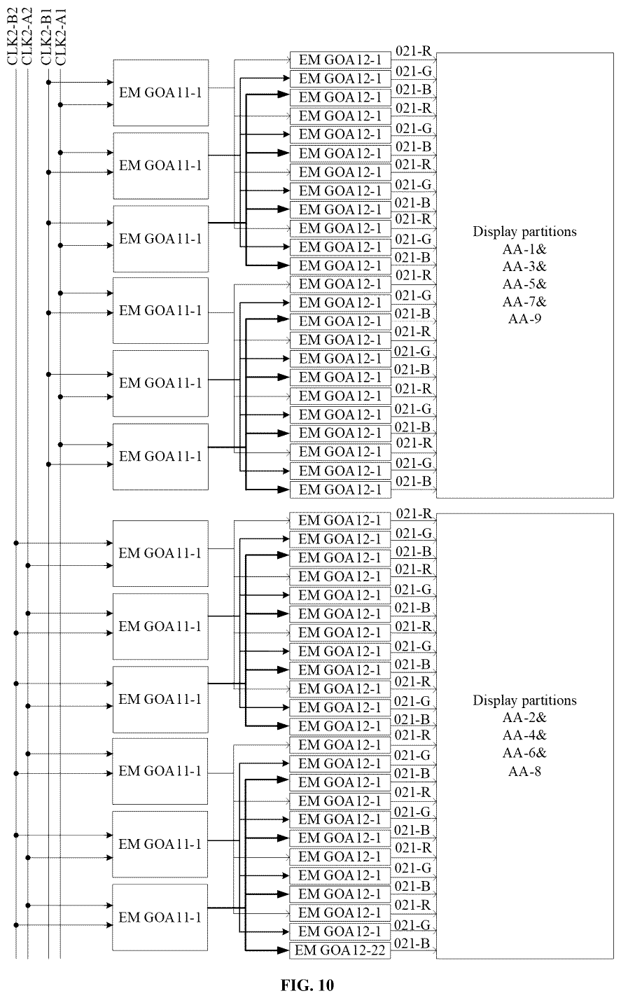

For example, referring to cascade-connection modes shown in FIG. 9 and FIG. 10, the plurality of light emission driving units 201 provided in the embodiments of the present disclosure may be divided into a plurality of light emission driving unit groups, and each of the light emission driving units group may include four adjacent light emission driving units 201 which are coupled to sub-pixels 021 of the same color. In addition, the four adjacent light emission driving units 201 in each of the light emission driving units group 201 share the same input sub-circuit 2011, that is, share the pull-up node PU and the pull-down node PD.

It should be noted that FIG. 10 shows a cascade-connection mode of a light emission driving unit by taking the light emission control circuit 20-1 as an example, the input sub-circuit 2011 is marked as EM GOA11; and the output sub-circuit 2012 is marked as EM GOA12. EM GOA12-1 refers to the light emission driving unit coupled to the first row of sub-pixels, and for other markers, it may be deduced by analogy. FIG. 11 shows a cascade-connection mode of a light emission driving unit by taking the reset driving circuit 20-2 and the compensation driving circuit 20-3 as an example, the input sub-circuit 2011 is marked as PWM GOA11; and the output sub-circuit 2012 is marked as PWM GOA12. PWM GOA12-1 refers to the light emission driving unit coupled to the first row of sub-pixels, and for other markers, it may be deduced by analogy.

Optionally, as shown in FIG. 8, the substrate 01 described in the embodiments of the present disclosure may include a plurality of display partitions AA arranged sequentially along the pixel column direction Y1. Each of the display partition AA may include at least two rows of pixels 02.

In conjunction with FIGS. 10 and 11, it can be seen that the plurality of second clock lines CLK2 may be divided into a plurality of groups of second clock lines, and each group of second clock lines may include at least two second clock lines CLK2. The various light emission driving units 201 coupled to the at least two rows of pixels 02 in one display partition AA may be coupled to one group of second clock lines CLK2, and the various light emission driving units 201 coupled to the at least two rows of pixels 02 in adjacent display partitions AA may be coupled to different groups of second clock lines CLK2.

For example, referring to FIG. 10 and FIG. 11, the plurality of light emission driving units 201 (including EM GOA11 and EM GOA12/PWM GOA11 and PWM GOA12) included in each of the light emission driving circuits 20 shown are coupled to four second clock lines CLK2, the four second clock lines CLK2 are divided into two groups of second clock lines, and each group of second clock lines include two second clock lines CLK2. The various light emission driving units 201 coupled to the at least two rows of pixels 02 in odd display partitions are coupled to one group of second clock lines CLK2 in two groups of second clock lines CLK2, and the various light emission driving units 201 coupled to the at least two rows of pixels 02 in even display partitions are coupled to the other group of second clock lines CLK2 in two groups of second clock lines CLK2. That is, on the basis of including 9 display partitions AA-1 to AA-9, in the display partitions AA-1, AA-3, AA-5, AA-7 and AA-9, the various light emission driving units 201 coupled to a plurality of rows of sub-pixels 021 may be coupled to one group of second clock lines CLK2, including two second clock lines CLK2 marked as CLK2-A1 and CLK2-B1; and in the display partitions AA-2, AA-4, AA-6 and AA-8, the various light emission driving units 201 coupled to a plurality of rows of sub-pixels 021 may be coupled to the other group of second clock lines CLK2, including two second clock lines CLK2 marked as CLK2-A2 and CLK2-B2.

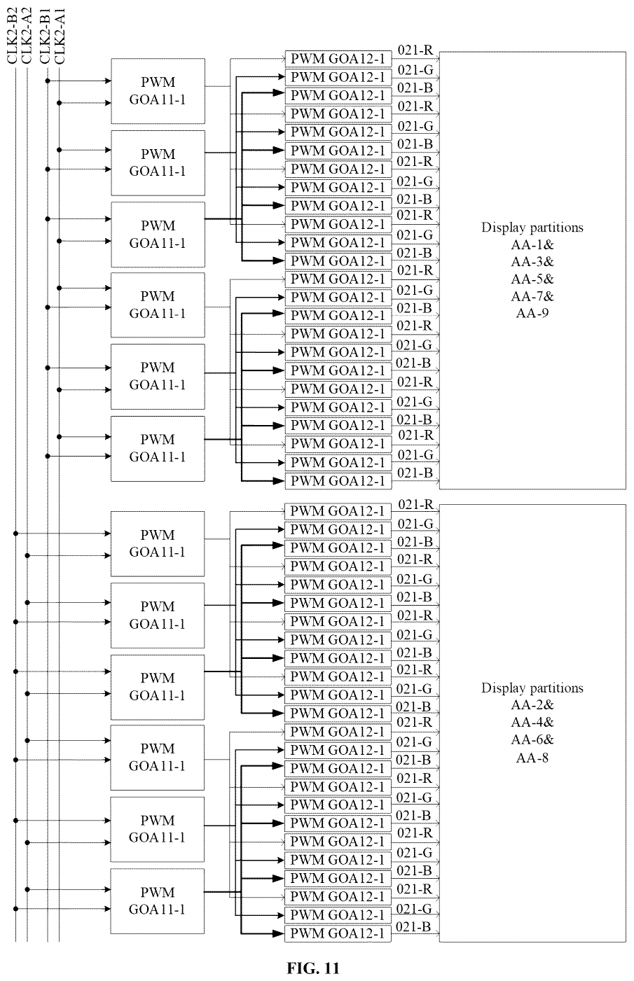

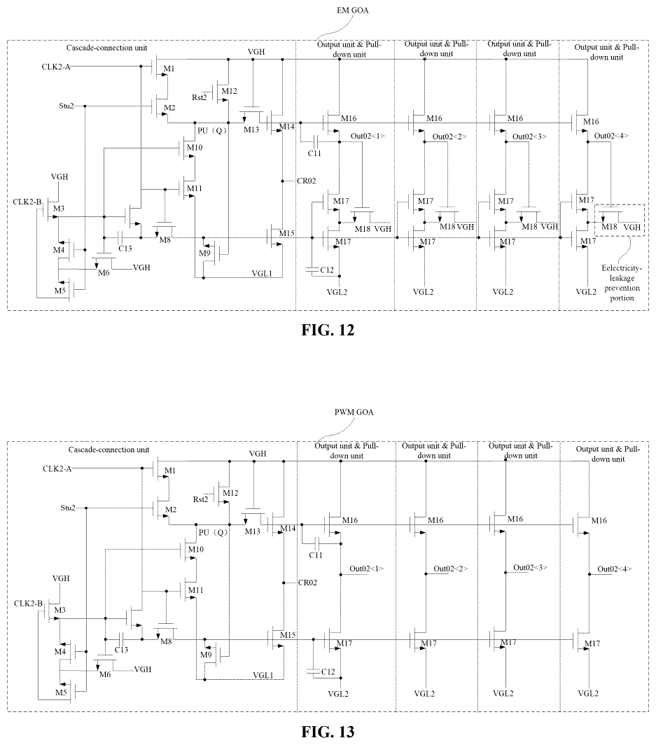

Optionally, by taking the light emission control circuit 20-1 as an example, FIG. 12 shows a diagram of a circuit structure of an EM GOA. By taking the reset driving circuit 20-2 and the compensation driving circuit 20-3 as an example, FIG. 13 shows a diagram of a circuit structure of a PWM GOA. In conjunction with FIGS. 9, 12 and 13, it can be seen that the input sub-circuit 2011 in each of the EM GOA and the PWM GOA may include a cascade-connection unit. The output sub-circuit 2012 in each of the EM GOA and the PWM GOA may include an output unit and a pull-down unit.

Optionally, the EM GOA shown in FIG. 12 is of a 19T3C structure, including 19transistors (M1 to M19) and 3 capacitors (C11, C12, and C13). The PWM GOA shown in FIG. 13 is of a 17T3C structure, including 17 transistors (M1 to M17) and 3 capacitors (C11, C12, and C13). In addition, the GOA shown in each of FIG. 12 and FIG. 13 is coupled to two second clock lines, CLK2-A and CLK2-B, and also coupled to a start signal terminal Stu2, a reset signal terminal Rst2, and power supply terminals VGH, VGL1, and VGL2 as well as a shift output terminal CR02 and a signal output terminal Out02. In addition, by comparing FIG. 12 and FIG. 13, it can be seen that the output sub-circuit 2012 of the light emission driving circuit 201 in the light emission control circuit 20-1 relative to the reset driving circuit 20-2 and the compensation driving circuit 20-3 may also include an electricity-leakage prevention portion, i.e., a transistor M18; and the transistor M17 shown in FIG. 12 includes two transistors connected in series and may be referred to as a double-gate structure, while the transistor M17 shown in FIG. 13 includes one transistor and is a single-gate structure. For other transistors described in the embodiments of the present disclosure, they may all be double-gate transistors, and thus the operation stability is better. In addition, a material of each transistor may include an oxide material. That is, the transistor may be an oxide transistor. Certainly, in some other embodiments, the EM GOA and the PWM GOA are also not limited to the above structures.

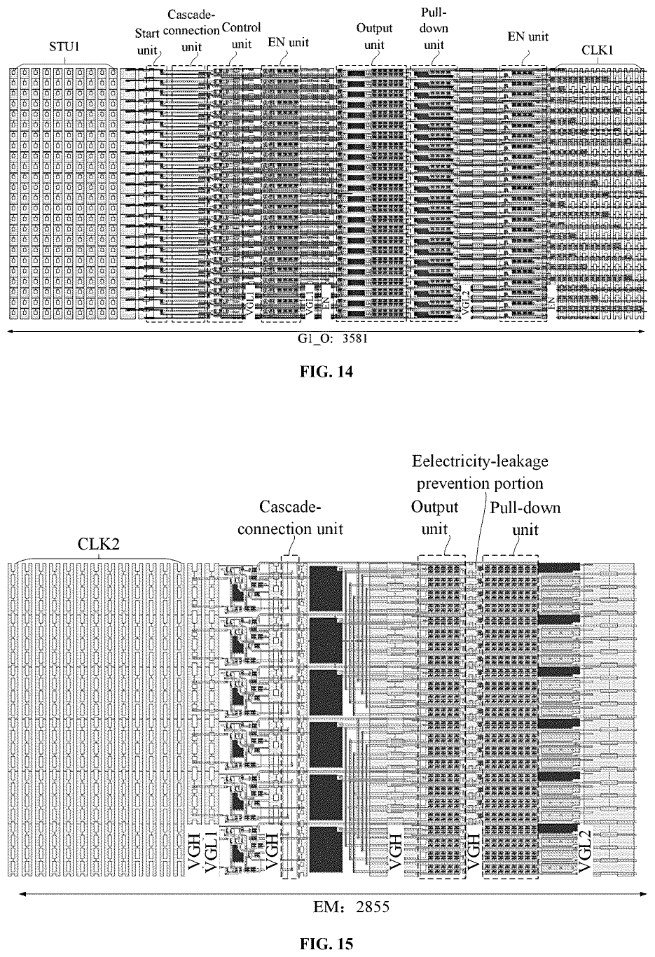

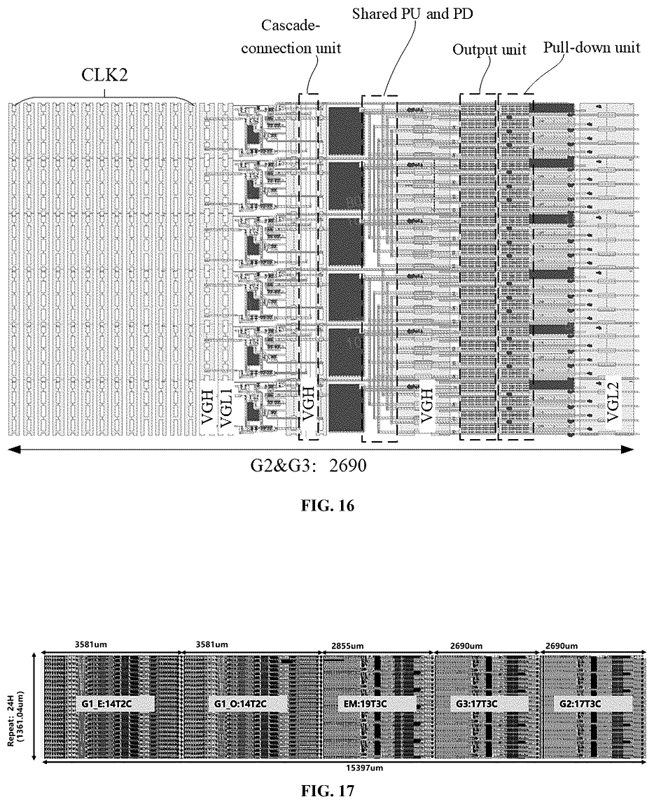

Optionally, by taking the structure shown in FIG. 7 as an example, FIG. 14 shows a structure layout of a Gate GOA. By taking the structure shown in FIG. 12 as an example, FIG. 15 shows a structural layout of an EM GOA. By taking the structure shown in FIG. 13 as an example, FIG. 16 shows a structural layout of a PWM GOA.

Firstly, the first start lines STU1, the first clock lines CLK1, the second start lines STU2 and the second clock lines CLK2 described in the embodiments of the present disclosure may all be AC driving lines. Each of the gate driving units 101 and each of the light emission driving units 201 may also be coupled to DC driving lines, such as power supply lines VGL and VGH.

Each of the gate driving units 101 may be configured to transmit a gate driving signal to the coupled first output line Out1 based on the first start signal, the first clock signal and driving signals provided by the coupled DC driving lines.

Each of the light emission driving units 201 may be configured to transmit a light emission driving signal to the coupled second output line Out2 based on the second start signal, the second clock signal and driving signals provided by the coupled DC driving lines.

In conjunction with the structure layouts shown in FIG. 14 to FIG. 16, it can be seen that in the embodiments of the present disclosure, for each driving circuit in the gate driving circuit 10 and the light emission driving circuit 20, the coupled DC driving lines are disposed on two sides of the driving circuit in the pixel row direction X1 and the AC driving lines coupled to each driving circuit is disposed on sides of the DC driving lines away from the driving circuit.

For example, by taking the Gate GOA as an example, in conjunction with the FIG. 14, it can be seen that the DC lines (including VGL1, VGL2 and EN) coupled to the Gate GOA are disposed on two sides, i.e., a left side and a right side, of each unit and the AC lines (including CLK1 and STU1) coupled to the Gate GOA are disposed on sides of the DC lines away from each unit. For example, STU1 is disposed on the leftmost side and CLK1 is disposed on the rightmost side. In this way, line crossing can be reduced. By taking the EM GOA and PWM GOA as an example, in conjunction with FIG. 15 and FIG. 16, it can also be seen that the DC lines (including VGL1, VGL2 and VGH) coupled thereto are all disposed on the two sides, i.e., a left side and a right side, of each unit; and the AC line (including CLK2) coupled thereto is disposed on sides of the DC lines away from the unit. By disposing the DC lines on two sides of the driving circuit in the pixel row direction X1 and the AC lines on the sides of the DC lines away from the driving circuit, an influence of signal interference on the operation of the driving circuit can be shielded, thereby further preventing interference with the signals transmitted to the pixels. In addition, it can be seen from the figure that each AC line is disposed on at least one side of each unit. In this way, line crossing in a transverse direction can be reduced.

Optionally, on the basis of FIG. 14 to FIG. 16, in conjunction with FIG. 4, FIG. 17 shows a structural layout of a driving circuit. Firstly, referring to FIG. 17, it can be seen that in the pixel row direction X1, the Gate GOA coupled to the gate line G1_E, the Gate GOA coupled to the gate line G1_O, the EM GOA coupled to the light emission control line EM, the PWM GOA coupled to the reset line G3, and the PWM GOA coupled to the compensation line G2 may be arranged from left to right in the direction approaching to the pixels. In addition, in the pixel row direction X1, in the figure, the width of the Gate GOA is 3581 micrometers (μm); the width of the EM GOA is 2855 μm; the width of each of the two PWM GOAs is 2690 μm, and the total width of the driving circuit is 15,397 μm. In the pixel column direction Y1, the width of each repeat unit in the driving circuit is 1361.04 μm, and the repeat unit includes 24 rows of sub-pixels 021.

It should be noted that the above dimensions are only for the description of the driving circuit of the specified structure described in the embodiments of the present disclosure, and are not intended to limit the width and length of the driving circuit.

Optionally, the pixel 02 includes a gate metal layer, a first insulating layer, a first source-drain (SD) metal layer, a second insulating layer and a second SD metal layer which are sequentially stacked in a direction away from the substrate. The first output lines Out1 and the second output lines Out2 may be disposed in the same layer as the second SD metal layer.

The expression “in the same layer” may refer to a layer structure formed by forming a film layer with the same film-forming process for forming a particular pattern and then patterning the film layer with the same mask through a one-time patterning process. According to different particular patterns, the one-time patterning process may include multiple exposures, development, or etching processes, and the particular pattern in the formed layer structure may be continuous or discontinuous. That is, a plurality of elements, components, structures and/or portions disposed in the “same layer” are made of the same material and formed by the same one-time patterning process. In this way, the manufacturing processes and manufacturing costs can be reduced, and the manufacturing efficiency can be improved.

Since a plurality of insulating layers are generally included below the second SD metal layer, the second SD metal layer is disposed as an output line. This can avoid some floating points where signals are unstable, and meanwhile the space in a longitudinal direction (i.e., pixel column direction Y1) can be saved.

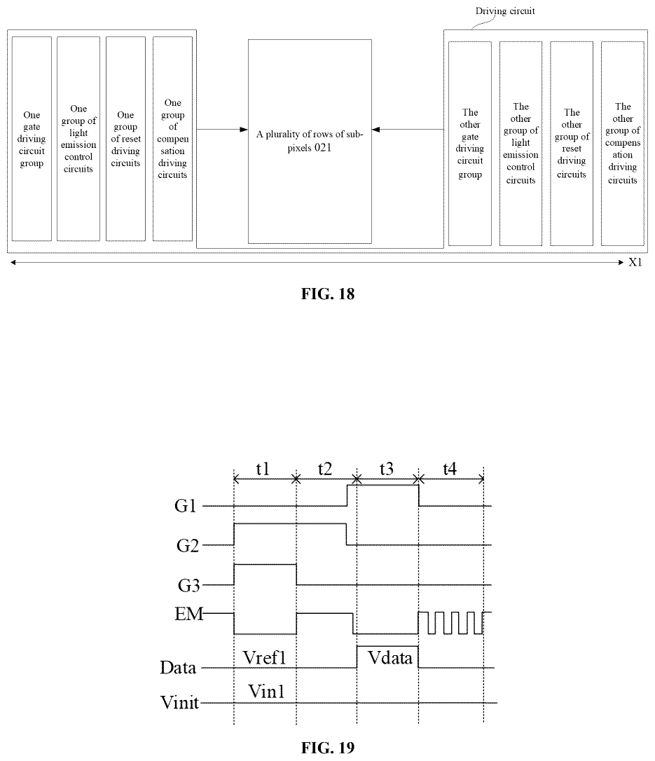

Optionally, FIG. 18 is a structural schematic diagram of a pixel driving circuit according to some embodiments of the present disclosure. As shown in FIG. 18, the driving circuit described in the embodiments of the present disclosure may include:
two gate driving circuit groups disposed at two sides of sub-pixels respectively in a pixel row direction X1,
two groups of light emission control circuits disposed at two sides of pixels respectively in the pixel row direction X1,
two groups of reset driving circuits disposed at two sides of the pixels respectively in the pixel row direction X1, and
two groups of compensation driving circuits disposed at two sides of the pixels respectively in the pixel row direction X1.

That is, in the embodiments of the present disclosure, for a plurality of rows of sub-pixels 021 in the display panel, GOAs may be disposed at two sides for driving, thereby improving the driving efficiency and the reliability.

By taking the sub-pixels shown in FIG. 3 as an example, assuming that each transistor is an N-type transistor and a first potential (i.e., an effective potential) is a high potential relative to a second potential (i.e., ineffective potential), the working principle of the sub-pixel is introduced as follows. FIG. 19 shows a sequence diagram of a signal of a sub-pixel.

Referring to FIG. 19, it can be seen that driving the sub-pixel to emit light may include the following four stages: a reset stage t1, a compensation stage t2, a data writing stage t3 and a light emission stage t4.

In the reset stage t1, the gate line G1 may provide a gate driving signal at a low potential, the light emission control line EM may provide a light emission control signal at a low potential, the compensation line G2 may provide a compensation signal at a high potential, and the reset line G3 may provide a reset signal at a high potential. In this way, the data writing transistor T1 and the light emission control transistor T4 are both turned off, and the compensation transistor T2 and the reset transistor T3 are both turned on. Correspondingly, the reference signal line Vref may transmit the reference signal Vref1 to the gate of the driving transistor T5 to reset the gate of the driving transistor T5, and the initial power supply line Vin1 may transmit the initial power supply signal Vin1 to the second electrode of the driving transistor T5 to reset the second electrode of the driving transistor T5.

In the compensation stage t2, the gate line G1 may continue to provide the gate driving signal at the low potential, the light emission control line EM may provide a light emission control signal at a high potential, the compensation line G2 may continue to provide the compensation signal at the high potential, and the reset line G3 may provide a reset signal at a low potential. In this way, the data writing transistor T1 and the reset transistor T3 are both turned off, and the compensation transistor T2 and the light emission control transistor T4 are both turned on. Correspondingly, the reference signal line Vref may continue to transmit the reference signal to the gate of the driving transistor T5 and the charging power supply line ELVDD may transmit the charging power supply signal to the first electrode of the driving transistor T5. Thus, the internal compensation of the second electrode of the driving transistor T5 can be achieved.

In the data writing stage t3, the gate line G1 may provide a gate driving signal at a high potential, the light emission control line EM may provide the light emission control signal at the low potential, the compensation line G2 may provide a compensation signal at a low potential, and the reset line G3 may continue to provide the reset signal at the low potential. In this way, the data writing transistor T1 is turned on, and the compensation transistor T2, the reset transistor T3 and the light emission control transistor T4 are all turned off. Correspondingly, the data line Data may transmit the data signal Vdata to the gate of the driving transistor T5 to write the data signal to the gate of the driving transistor T5.

In the light emission stage t4, the gate line GI may provide the gate driving signal at the low potential, the light emission control line EM may provide the light emission control signal at the high potential, the compensation line G2 may continue to provide the compensation signal at the low potential, and the reset line G3 may continue to provide the reset signal at the low potential. In this way, the light emission control transistor T4 is turned on, and the data writing transistor T1, the compensation transistor T2 and the reset transistor T3 are all turned off. In addition, at this time, the potential of the data signal written to the gate of the gate driving transistor T5 in the previous stage (i.e., data writing stage t3) is a high potential, and the driving transistor T5 is turned on. Thus, the charging power supply line ELVDD is conducted with the pull-down power supply line ELVSS, and the light-emitting element 0212 emits light.

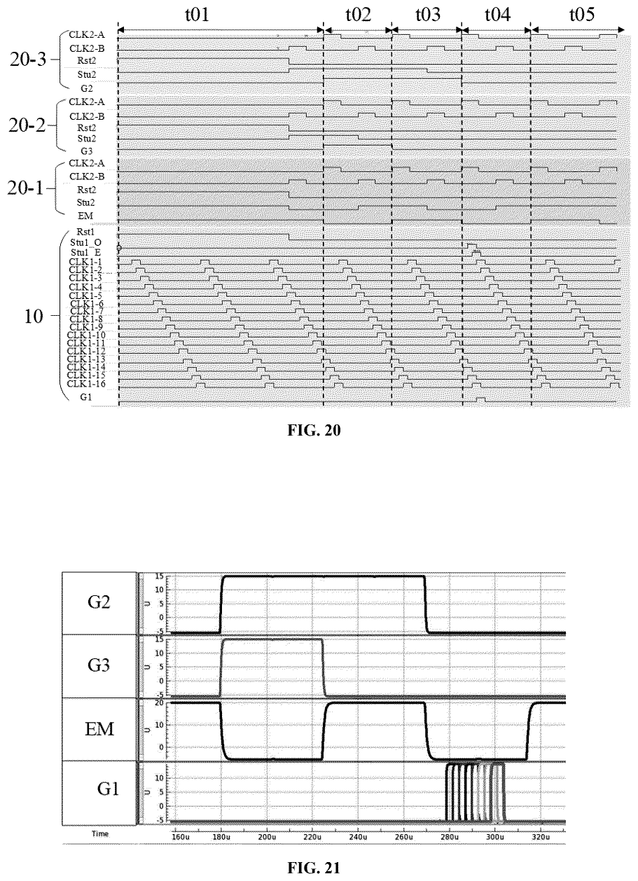

Based on the descriptions of the above embodiments, it can be seen that it needs to dispose a driving circuit to provide the signals as shown in FIG. 19 to the sub-pixels. Thus, on the basis of the structure shown in FIG. 19, by taking the driving circuits shown in FIG. 7, FIG. 12 and FIG. 13 as an example, FIG. 20 shows a sequence diagram of signals of coupled various circuits in the driving circuit.

Referring to FIG. 20, it can be seen that the whole driving process may include the following five stages: a reset stage t01, a pixel reset stage t02, a compensation stage t03, a data writing stage t04 and a light emission stage 105 of the GOA. The pixel reset stage t02, the compensation stage t03, the data writing stage t04 and the light emission stage t05 may be described with reference to the sequence diagram and the embodiment shown in FIG. 20.

In the reset stage t01 of the GOA, the reset signals of the reset signal lines coupled to the gate driving circuit 10 (i.e., Gate GOA) that provides the gate driving signal to the gate line G1, the light emission control circuit 20-1 (i.e., EM GOA) that provides the light emission control signal to the light emission control line EM, the compensation driving circuit 20-3 that provides the compensation signal to the compensation line G2, and the reset driving circuit 20-2 (i.e., PWM GOA) that provides the reset signal to the reset line G3 may all be pulled up. In the gate driving circuit 10, the compensation driving circuit 20-3 and the reset driving circuit 20-2, the potential of the pull-up node PU is pulled down and the potential of the pull-down node PD is pulled up. In addition, in the light emission control circuit 20-1, the potential of the pull-up node PU is pulled up, and the potential of the pull-down node PD is pulled down. Thus, the resetting of the various driving circuits is achieved.

In the pixel reset stage t02, by controlling potentials of various signal terminals coupled to the gate driving circuit 10, the light emission control circuit 20-1, the compensation driving circuit 20-3 and the reset driving circuit 20-2 to satisfy a form of the stage t02 shown in FIG. 20, so that at this time, the gate driving circuit 10 provides the gate driving signal at the low potential to the gate line G1, the light emission control circuit 20-1 provides the light emission control signal at the low potential to the light emission control line EM, the compensation driving circuit 20-3 provides the compensation signal at the high potential to the compensation line G2, and the reset driving circuit 20-2 provides the reset signal at the high potential to the reset line G3. Thus, it is ensured that the reliable resetting of the G node and the S node in the sub-pixel is realized according to the reset stage t1 shown in FIG. 19.

In the compensation stage t03, by controlling the potentials of various signal terminals coupled to the gate driving circuit 10, the light emission control circuit 20-1, the compensation driving circuit 20-3 and the reset driving circuit 20-2 to satisfy a form of the stage t03 shown in FIG. 20, so that at this time, the gate driving circuit 10 provides the gate driving signal at the low potential to the gate line G1, the light emission control circuit 20-1 provides the light emission control signal at the high potential to the light emission control line EM, the compensation driving circuit 20-3 provides the compensation signal at the high potential to the compensation line G2, and the reset driving circuit 20-2 provides the reset signal at the low potential to the reset line G3. Thus, it is ensured that internal compensation of the S node in the sub-pixel is realized according to the compensation stage t2 shown in FIG. 19. The compensation signal at the high potential is provided to the compensation line G2, so that a time when the compensation transistor T2 is turned on may be equal to the sum of the duration of the reset stage t1 and the compensation stage t2. The time when the compensation signal at the high potential is provided to the compensation line G2 and the light emission control signal at the high potential is provided to the light emission control line EM is the time when the internal compensation is performed.

In the data writing stage 104, by controlling the potentials of various signal terminals coupled to the gate driving circuit 10, the light emission control circuit 20-1, the compensation driving circuit 20-3 and the reset driving circuit 20-2 to satisfy a form of the stage t04 shown in FIG. 20, so that at this time, the gate driving circuit 10 provides the gate driving signal at the high potential to the gate line G1, the light emission control circuit 20-1 provides the light emission control signal at the low potential to the light emission control line EM, the compensation driving circuit 20-3 provides the compensation signal at the low potential to the compensation line G2, and the reset driving circuit 20-2 provides the reset signal at the low potential to the reset line G3. Thus, it is ensured that the data signal is written to the G node in the sub-pixel according to the data writing stage t3 shown in FIG. 19.

In the light emission stage t05, by controlling the potentials of various signal terminals coupled to the gate driving circuit 10, the light emission control circuit 20-1, the compensation driving circuit 20-3 and the reset driving circuit 20-2 to satisfy a form of the stage t05 shown in FIG. 20, so that at this time, the gate driving circuit 10 provides the gate driving signal at the low potential to the gate line G1, the light emission control circuit 20-1 provides the light emission control signal at the high potential to the light emission control line EM, the compensation driving circuit 20-3 provides the compensation signal at the low potential to the compensation line G2, and the reset driving circuit 20-2 provides the reset signal at the low potential to the reset line G3. Thus, it is ensured that the light-emitting element 0212 is reliably driven to emit light according to the light emission stage t4 shown in FIG. 19.

Optionally, on the basis of the time sequence shown in FIG. 19, FIG. 21 further shows a sequence simulation diagram. The sequence simulation diagram includes a gate driving signal provided by the driving circuit to the gate line GI coupled to eight adjacent rows of sub-pixels, a light emission control signal provided by the driving circuit to the light emission control line EM, a compensation signal provided by the driving circuit to the compensation line G2, and a reset signal provided by the driving circuit to the reset line G3, where the abscissa refers to time in microseconds (us); and the ordinate refers to the voltage in volts (V).

On the basis of the driving above, by taking the structures shown in FIG. 5, FIG. 10 and FIG. 11 as an example, in a 3D display scenario, it is possible to light up four rows of red sub-pixels 021-R firstly, then light up four rows of green sub-pixels 021-G, and subsequently light up four rows of blue sub-pixels 021-B. The expression “light up” here refers to the process of witting the data signal to the sub-pixel. If high-definition display needs to be achieved, the first clock signals may be provided to the sixteen first clock lines CLK1-1 to CLK1-16 in the sequence shown in FIG. 20, that is, the first clock signals received by every four adjacent rows of sub-pixels of the same color are independent of each other and do not merge, and at this time, it may be considered that sixteen first clock lines CLK are required. If medium-definition display needs to be achieved, it is possible to merge the first clock signals received by every two adjacent rows of sub-pixels of the same color and at this time, it may be considered that eight first clock lines CLK are required. If low-definition display needs to be achieved, it is possible to merge the first clock signals received by every four adjacent rows of sub-pixels of the same color and at this time, it may be considered that four first clock lines CLK are required. In this way, power consumption can be reduced. It should be noted that the expression “merge” here refers to that the sequences of various first clock signals that are merged are identical. Certainly, for other display scenarios, the display mode and the clock signal may be adjusted, which is not limited by the embodiments of the present disclosure.

In summary, the embodiments of the present disclosure provide the driving circuit of the display panel. The driving circuit includes the gate driving circuit group and the light emission driving circuit group which are arranged sequentially along the pixel row direction. The gate driving circuit group includes the plurality of gate driving circuits arranged sequentially along the pixel row direction and the light emission driving circuit group includes the plurality of light emission driving circuits arranged sequentially along the pixel row direction. Each of the gate driving circuits includes the plurality of gate driving units cascade-connected along the pixel column direction. Each of the light emission driving circuits includes the plurality of light emission driving circuit cascade-connected along the pixel column direction. The gate driving circuit is configured to transmit the gate driving signals to the plurality of rows of sub-pixels. The light emission driving circuit is configured to transmit the light emission driving signals to the plurality of rows of sub-pixels to drive the plurality of rows of sub-pixels to emit light. In this way, for the display panel with relatively high resolution (i.e., including a large number of rows of sub-pixels), a plurality of driving circuits may be arranged along the pixel row direction to drive the sub-pixels to emit light, which is conductive to layout arrangement.

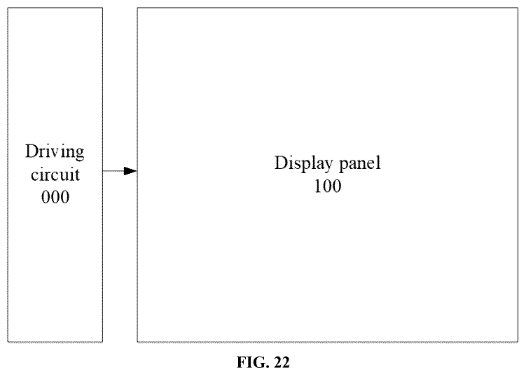

FIG. 22 is a structural schematic diagram of a display device according to some embodiments of the present disclosure. As shown in FIG. 22, the display device includes a display panel 100, the driving circuit 000 as descried in the above embodiment.

Referring to FIG. 1, the display panel 100 includes a substrate 01, and a plurality of pixels 02 disposed on the substrate 01. The driving circuit 000 is coupled to the plurality of pixels 02 and configured to transmit scanning driving signals and light emission driving signals to the plurality of pixels 02. The plurality of pixels 02 are configured to emit light based on the scanning driving signals and the light emission driving signals.

Optionally, the display device described in the embodiments of the present disclosure may be any product or component having a display function, such as an organic light-emitting diode (OLED) display device, electronic paper, a mobile phone, a tablet computer, a television, a display, a laptop computer or a navigator.

It should be understood that the terms used in the embodiments of the present disclosure are merely intended to explain the embodiments of the present disclosure, instead of limiting the present disclosure. Unless defined otherwise, the technical terms or scientific terms used in the embodiments of the present disclosure shall have the general meaning understood by persons of ordinary skill in the art.

For example, the terms “first”, “second”, “third” and similar terms used in the description and claims of the present disclosure do not denote any order, quantity, or importance, and are merely used to distinguish between different components.

Likewise, the term “one” or “a/an” and similar terms denote at least one, instead of limiting the quantity.

The word “comprise” or “include” and similar terms mean that the element or object appearing before the word “comprise” or “include” covers the listed elements, objects and equivalents thereof appearing after the word “comprise” or “include”, without excluding other elements or objects.

The terms “upper”, “lower”, “left”, right” and the like are used to indicate a relative positional relationship. When an absolute position of the described object changes, the relative positional relationship is also changed accordingly. The word “connected” or “coupled” refers to an electrical connection.

The term “and/or” indicates the existence of three types of relationships. For example, A and/or B indicates: A exists alone, A and B exist simultaneously, and B exists alone. The character “/” generally indicates that the associated objects are in an “or” relationship.

The above descriptions are merely optional embodiments of the present disclosure, and are not intended to limit the present disclosure. Any modifications, equivalent replacements, improvements and the like made within the spirit and principles of the present disclosure shall be included within the scope of protection of the present disclosure.

1. A driving circuit of a display panel, wherein the display panel comprises a substrate, and a plurality of pixels disposed on the substrate and arranged in an array, wherein each of the pixels comprises a plurality of sub-pixels which are arranged along a pixel column direction and have different colors; and the driving circuit comprises:
a gate driving circuit group and a light emission driving circuit group which are arranged sequentially along a pixel row direction, wherein
the gate driving circuit group comprises a plurality of gate driving circuits arranged sequentially along the pixel row direction, wherein each of the gate driving circuits comprises a plurality of gate driving units cascade-connected along the pixel column direction;
the light emission driving circuit group comprises a plurality of light emission driving circuits arranged sequentially along the pixel row direction, wherein each of the light emission driving circuits comprises a plurality of light emission driving units cascade-connected along the pixel column direction;
gate driving units comprised in the plurality of gate driving circuits are coupled to a plurality of rows of sub-pixels through a plurality of first output lines, the plurality of gate driving units comprised in each of the gate driving circuits are also respectively coupled to a first start line and a plurality of first clock lines, and first output lines, first start lines and first clock lines coupled to different plurality of gate driving units comprised in the gate driving circuits are different; the plurality of gate driving units comprised in each of the gate driving circuits are configured to transmit gate driving signals to coupled first output lines based on a first start signal provided by coupled first start line and first clock signals provided by coupled first clock lines;
the plurality of light emission driving units comprised in each of the light emission driving circuits are coupled to the plurality of rows of sub-pixels through a plurality of second output lines, the plurality of light emission driving units comprised in each of the light emission driving circuits are also respectively coupled to a second start line and a plurality of second clock lines, and second output lines, second start lines and second clock lines coupled to different plurality of light emission driving units comprised in the various light emission driving circuits are different; and the plurality of light emission driving units comprised in each of the light emission driving circuits are configured to transmit light emission driving signals to coupled second output lines based on a second start signal provided by coupled second start line and second clock signals provided by coupled second clock lines.

2. The driving circuit according to claim 1, wherein the light emission driving circuit group comprises three light emission driving circuits: a light emission control circuit, a reset driving circuit and a compensation driving circuit; and
the plurality of gate driving circuits, the light emission control circuit, the reset driving circuit and the compensation driving circuit are arranged sequentially in a direction approaching to the pixels along the pixel row direction.

3. The driving circuit according to claim 1, wherein the plurality of first clock lines is divided into a plurality of groups of first clock lines, and each group of first clock lines comprise at least two first clock lines;
each of the gate driving circuits comprises a plurality of gate driving sub-circuits; each of the gate driving sub-circuits is coupled to the plurality of groups of first clock lines and comprises a plurality of gate driving unit groups in one-to-one correspondence with the plurality of rows of pixels, and the gate driving sub-circuits respectively correspond to different rows of pixels; and
each of the gate driving unit groups comprises a plurality of gate driving units coupled to a plurality of rows of sub-pixels in a corresponding row of pixels in one-to-one correspondence, and the plurality of gate driving unit groups are coupled to the plurality of groups of first clock lines in one-to-one correspondence.

4. The driving circuit according to claim 3, wherein gate driving units comprised in each of the gate driving circuits are coupled to eight first clock lines, the eight first clock lines are divided into four groups of first clock lines, and each group of first clock lines comprise two first clock lines; and
each of the pixels comprises three sub-pixels which are arranged in the pixel column direction and have different colors; each of the gate driving sub-circuits comprises: four gate driving unit groups in a one-to-one correspondence with four rows of pixels; and each of the gate driving unit groups comprises three gate driving units which are coupled to three rows of sub-pixels in a corresponding row of pixels in one-to-one correspondence.

5. The driving circuit according to claim 1, wherein the gate driving circuit group comprises two gate driving circuits arranged sequentially in the pixel row direction;
wherein gate driving units comprised in one gate driving circuit are coupled to a plurality of odd rows of sub-pixels through a plurality of first output lines in one-to-one correspondence; and
gate driving units comprised in the other gate driving circuit are coupled to a plurality of even rows of sub-pixels through a plurality of first output lines in one-to-one correspondence.

6. The driving circuit according to claim 1, wherein the substrate comprises a plurality of display partitions arranged sequentially along the pixel column direction, wherein each of the display partition comprises at least two rows of pixels; and
the driving circuit comprises a plurality of gate driving circuit groups which are in one-to-one correspondence with the plurality of display partitions and arranged sequentially along the pixel column direction.

7. The driving circuit according to claim 6, further comprising a dummy driving circuit group disposed in at least one display partition, wherein the dummy driving circuit group comprises dummy circuits respectively corresponding to the gate driving circuits, and the dummy circuit comprises a plurality of dummy units;
wherein in the plurality of dummy units, one part of dummy units is disposed at a side, away from the gate driving unit coupled to a last row of sub-pixels, of the gate driving unit coupled to a first row of sub-pixels in a corresponding gate driving circuit, and is cascade-connected sequentially along the pixel column direction; and the other part of dummy units is disposed at a side, away from the gate driving unit coupled to a first row of sub-pixels, of the gate driving unit coupled to a last row of sub-pixels in a corresponding gate driving circuit, and is cascade-connected sequentially along the pixel column direction.

8. The driving circuit according to claim 7, wherein a number of the dummy units is the same as a number of the first clock lines, and in the plurality of dummy units, a number of the one part of dummy units is the same as a number of the other part of dummy units.

9. The driving circuit according to claim 1, wherein each of the light emission driving units comprises an input sub-circuit and an output sub-circuit; wherein
the input sub-circuit is respectively coupled to-the a corresponding second start line, a corresponding second clock line and a control node, and is configured to control a potential of the control node based on the corresponding second start signal and the corresponding second clock signal;
the output sub-circuit is respectively coupled to the control node and a corresponding second output line, and is configured to transmit a light emission driving signal to the corresponding second output line based on the potential of the control node; and
at least two light emission driving units share the same input sub-circuit.

10. The driving circuit according to claim 9, wherein the plurality of light emission driving units is divided into a plurality of light emission driving unit groups, and each of the light emission driving units group comprises four adjacent light emission driving units which are coupled to sub-pixels having the same color; and
the four adjacent light emission driving units in each of the light emission driving units group share the same input sub-circuit.

11. The driving circuit according to claim 1, wherein the substrate comprises a plurality of display partitions arranged sequentially along the pixel column direction, wherein each of the display partition comprises at least two rows of pixels; and
the plurality of second clock lines are divided into a plurality of groups of second clock lines, wherein each group of second clock lines comprise at least two second clock lines; and the light emission driving units coupled to the at least two rows of pixels in one display partition are coupled to one group of second clock lines, and the light emission driving units coupled to the at least two rows of pixels in adjacent display partitions are coupled to different groups of second clock lines.

12. The driving circuit according to claim 11, wherein the plurality of light emission driving units comprised in each of the light emission driving circuits are coupled to four second clock lines, the four second clock lines are divided into two groups of second clock lines, and each group of second clock lines comprise two second clock lines;
wherein the light emission driving units coupled to the at least two rows of pixels in odd display partitions are coupled to one group of second clock lines in the two groups of second clock lines, and the light emission driving units coupled to the at least two rows of pixels in even display partitions are coupled to the other group of second clock lines in the two groups of second clock lines.

13. The driving circuit according to claim 1, wherein the first start line, the first clock line, the second start line and the second clock line are alternating-current driving lines;
each of the gate driving units and each of the light emission driving units are further coupled to a direct-current driving line, each of the gate driving units is configured to transmit a gate driving signal to coupled first output line based on the first start signal, the first clock signal, and a driving signal provided by coupled direct-current driving line, and each of the light emission driving units is configured to transmit a light emission driving signal to coupled second output line based on the second start signal, the second clock signal, and a driving signal provided by coupled direct-current driving line; and
for each driving circuit in the gate driving circuit and the light emission driving circuit, the coupled direct-current driving lines are disposed at two sides of the driving circuit in the pixel row direction, and the alternating-current driving lines coupled to the driving circuit are disposed at sides of the direct-current driving lines away from the driving circuit.

14. The driving circuit according to claim 1, wherein each of the pixels-the pixel comprises a gate metal layer, a first insulating layer, a first source-drain metal layer, a second insulating layer and a second source-drain metal layer which are sequentially stacked in a direction away from the substrate;
wherein, the first output lines and the second output lines are disposed in the same layer as the second source-drain metal layer.

15. A display device, comprising a display panel wherein and a driving circuit, wherein
the display panel comprises a substrate, and a plurality of pixels disposed on the substrate and arranged in an array, wherein each of the pixels comprises a plurality of sub-pixels which are arranged along a pixel column direction and have different colors; the driving circuit is coupled to the plurality of pixels and is configured to transmit scanning driving signals and light emission driving signals to the plurality of pixels; and the plurality of pixels are configured to emit light based on the scanning driving signals and the light emission driving signals;
the driving circuit comprises:
a gate driving circuit group and a light emission driving circuit group which are arranged sequentially along a pixel row direction, wherein
the gate driving circuit group comprises a plurality of gate driving circuits arranged sequentially along the pixel row direction, wherein each of the gate driving circuits comprises a plurality of gate driving units cascade-connected along the pixel column direction;
the light emission driving circuit group comprises a plurality of light emission driving circuits arranged sequentially along the pixel row direction, wherein each of the light emission driving circuits comprises a plurality of light emission driving units cascade-connected along the pixel column direction;
gate driving units comprised in the plurality of gate driving circuits are coupled to a plurality of rows of sub-pixels through a plurality of first output lines, the plurality of gate driving units comprised in each of the gate driving circuits are also respectively coupled to a first start line and a plurality of first clock lines, and first output lines, first start lines and first clock lines coupled to different plurality of gate driving units comprised in the gate driving circuits are different; the plurality of gate driving units comprised in each of the gate driving circuits are configured to transmit gate driving signals to coupled first output lines based on a first start signal provided by coupled first start line and first clock signals provided by coupled first clock lines;
the plurality of light emission driving units comprised in each of the light emission driving circuits are coupled to the plurality of rows of sub-pixels through a plurality of second output lines, the plurality of light emission driving units comprised in each of the light emission driving circuits are also respectively coupled to a second start line and a plurality of second clock lines, and second output lines, second start lines and second clock lines coupled to different plurality of light emission driving units comprised in the various light emission driving circuits are different; and the plurality of light emission driving units comprised in each of the light emission driving circuits are configured to transmit light emission driving signals to coupled second output lines based on a second start signal provided by coupled second start line and second clock signals provided by coupled second clock lines.

16. The display device according to claim 15, wherein the light emission driving circuit group comprises three light emission driving circuits: a light emission control circuit, a reset driving circuit and a compensation driving circuit; and
the plurality of gate driving circuits, the light emission control circuit, the reset driving circuit and the compensation driving circuit are arranged sequentially in a direction approaching to the pixels along the pixel row direction.

17. The display device according to claim 15, wherein the plurality of first clock lines is divided into a plurality of groups of first clock lines, and each group of first clock lines comprise at least two first clock lines;
each of the gate driving circuits comprises a plurality of gate driving sub-circuits; each of the gate driving sub-circuits is coupled to the plurality of groups of first clock lines and comprises a plurality of gate driving unit groups in one-to-one correspondence with the plurality of rows of pixels, and the gate driving sub-circuits respectively correspond to different rows of pixels; and
each of the gate driving unit groups comprises a plurality of gate driving units coupled to a plurality of rows of sub-pixels in a corresponding row of pixels in one-to-one correspondence, and the plurality of gate driving unit groups are coupled to the plurality of groups of first clock lines in one-to-one correspondence.

18. The display device according to claim 17, wherein gate driving units comprised in each of the gate driving circuits are coupled to eight first clock lines, the eight first clock lines are divided into four groups of first clock lines, and each group of first clock lines comprise two first clock lines; and
each of the pixels comprises three sub-pixels which are arranged in the pixel column direction and have different colors; each of the gate driving sub-circuits comprises: four gate driving unit groups in a one-to-one correspondence with four rows of pixels; and each of the gate driving unit groups comprises three gate driving units which are coupled to three rows of sub-pixels in a corresponding row of pixels in one-to-one correspondence.

19. The display device according to claim 15, wherein the gate driving circuit group comprises two gate driving circuits arranged sequentially in the pixel row direction;
wherein gate driving units comprised in one gate driving circuit are coupled to a plurality of odd rows of sub-pixels through a plurality of first output lines in one-to-one correspondence; and gate driving units comprised in the other gate driving circuit are coupled to a plurality of even rows of sub-pixels through a plurality of first output lines in one-to-one correspondence.

20. The display device according to claim 15, wherein the substrate comprises a plurality of display partitions arranged sequentially along the pixel column direction, wherein each of the display partition comprises at least two rows of pixels; and
the driving circuit comprises a plurality of gate driving circuit groups which are in one-to-one correspondence with the plurality of display partitions and arranged sequentially along the pixel column direction.
